(19) United States
(12) Patent Application Publication
(10) Pub. No.: US 2008/0014401 A1
(43) Pub. Date: Jan. 17, 2008

(54) Optical information-recording medium and method for producing the same

(75) Inventors: Keita Takahashi, Shinagawa-ku (JP); Kazutoshi Katayama, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Minato-ku (JP)

(21) Appl. No.: 11/822,104

(22) Filed: Jul. 2, 2007

(30) Foreign Application Priority Data
Jul. 12, 2006 (JP) 2006-191259

(51) Int. Cl. B32B 1/00; B05D 3/00

(52) U.S. Cl. 428/64.8; 427/384

(57) ABSTRACT

A first write-once type recording layer, on which information can be recorded by being irradiated with a laser beam having a wavelength of not more than 450 nm, is provided on a first substrate of a first optical information-recording medium. A dye compound, which contains boron as a constitutive element, is contained in the first write-once type recording layer. Preferred examples of the dye compound include boronic acid. In particular, it is preferable to use a compound having a boroxin moiety formed by condensation of boronic acid. The condensation of boronic acid can be advanced such that a solution, which is prepared by dissolving boronic acid in a solvent, is applied onto the first substrate to form the first write-once type recording layer, and then the first write-once type recording layer is subjected to an annealing treatment.

### BACKGROUND OF THE INVENTION

1. Field of the Invention

The present invention relates to an optical information-recording medium on which information can be recorded and reproduced by using a laser beam, and a method for producing the same. In particular, the present invention relates to an optical information-recording medium provided with a recording layer containing a dye compound which contains boron as a constitutive element, and a method for producing the same.

2. Description of the Related Art

An optical information-recording medium (optical disk), on which information can be recorded only once by using a laser beam, has been hitherto known. The optical disk is also referred to as “write-once type CD” (so-called CD-R). The typical structure thereof includes a recording layer which is composed of a methine dye, a light-reflective layer which is composed of a metal such as gold, and a protective layer which is made of resin, the layers being provided in this order in a stacked state on a transparent disk-shaped substrate. Information is recorded on a CD-R by radiating a laser beam in a near infrared region (usually a laser beam having a wavelength around 780 nm) onto the CD-R. The irradiated portion of the recording layer absorbs the laser beam, and the temperature at this position is locally raised. The physical or chemical change (for example, pit formation) is thus caused to change the optical characteristic thereof, and then the information is recorded. On the other hand, information is read (reproduced) by radiating a laser beam having the same wavelength as that of the recording laser beam. The information is reproduced by detecting the difference in reflectance between the portion in which the optical characteristics of the recording layer are changed (recorded area) and the portion in which the optical characteristics are not changed (unrecorded area).

Recently, the network such as the Internet and the high-definition television are rapidly widespread. The digital HDTV (High Definition Television) will become common soon. In view of these circumstances, a recording medium having a large capacity in order to record the image information inexpensively and conveniently is highly demanded. Although CD-Rs described above and DVD-Rs which enable the high density recording by using a visible laser beam (630 nm to 680 nm) as the recording laser beam are expected to be used as a large-capacity recording medium in the future. However, it is not affirmed that such recording mediums do not have a large recording capacity sufficient to meet expected requirements for much larger capacity.

In view of the above, an optical disk in which the recording density is improved and the larger recording capacity is provided has been studied and developed by using a laser beam having a wavelength shorter than that for DVD-R, specifically a wavelength of not more than 530 nm. That is, an information-recording and reproducing method has been proposed, in which information is recorded and reproduced by radiating blue (wavelength: 430 nm, 488 nm) laser beam or blue-green (wavelength: 515 nm) laser beam in a direction directed from a side of a recording layer to a side of a light-reflective layer of an optical disk provided with the recording layer containing, for example, an organic dye of a porphyrin compound, an azo-based dye, a metal azo-based dye, a quinophthalone-based dye, a trimethine cyanine dye, a dicyanovinylphenyl skeleton dye, a coumarin compound, a phthalocyanine compound, or a naphthalocyanine compound. On the other hand, an information recording and reproducing method has been also proposed, in which information is recorded and reproduced by radiating a laser beam having a wavelength of not more than 550 nm onto an optical disk which contains, as an organic dye, an oxonol dye in a recording layer (see, for example, U.S. Pat. Nos. 6,969,764 and 7,094,516, and United States Patent Publication Nos. 2002/76648, 2003/138728 and 2006/286338).

In general, the recording layer is provided such that an organic dye is dissolved in a solvent to prepare a solution, and the solution is applied onto a substrate, followed by being dried.

At present, an optical recording disk has been commercially available as the optical disk of this type to utilizing the short wavelength for the recording and reproduction, which is referred to as “Blu-ray system” based on the use of a blue laser at 405 nm.

In the information-recording method based on the use of the laser beam as described above, the irradiated portion of the recording layer undergoes the local increase in the temperature by absorbing the laser beam. Accordingly, a pit is formed at the portion. Therefore, when the short wavelength laser beam is radiated in order to form another pit in the vicinity of the pit after forming the pit, the pit, which has been previously formed, is deformed in some cases (this phenomenon will be hereinafter referred to as “adjacent interference”). The more conspicuous the inconvenience is, the shorter wavelength the laser beam has, in other words, the larger capacity the optical disk has.

According to the research by the present inventors, the recording characteristics are not sufficient due to the adjacent interference in the case of the optical disk provided with the recording layer containing the known dye compound as described above.

In order to avoid the inconvenience as described above, an organic dye, which forms a hard amorphous film, is expected to be used. However, such an organic dye is low in the solubility in the solvent. Inconveniently, it is difficult to perform the preparation itself of any solution as a raw material for providing the recording layer.

A water-soluble organic dye for an ink-jet printer composed of an organic boron compound is disclosed in U.S. Pat. Nos. 5,108,502 and 5,810,915. These patents disclose that their water-soluble organic dyes are strongly bonded to the paper in any case. Accordingly, the excellent dirt resistance and the water resistance are expressed, and the printing quality is improved. However, in those patents, any investigation is not made at all from such a view point that the organic dye for the optical disk is required to simultaneously have the characteristics that the hard amorphous film can be formed and that the solubility is high with respect to the solvent.

### SUMMARY OF THE INVENTION

A principal object of the present invention is to provide an optical information-recording medium provided with a recording layer containing a dye compound which makes it possible to simultaneously provide both of improvement in printing quality and satisfactory solubility in a solvent.

Another object of the present invention is to provide a method for producing the optical information-recording medium as described above.

The objects of the present invention are appropriately achieved in accordance with the following requirements.

[1] An optical information-recording medium having, on a substrate, a recording layer capable of recording information by being irradiated with a laser beam, wherein the recording layer contains a dye compound which contains boron as a constitutive element.

[2] The optical information-recording medium according to [1], wherein the dye compound has a dye residue having an absorption maximum wavelength of 300 nm to 900 nm, and a molar absorption coefficient ε[L/(mol·cm)] of the dye component is not less than 5,000.

[3] The optical information-recording medium according to [1] or [2], wherein the dye compound is a dye selected from the group consisting of oxonol dye, cyanine dye, styryl dye, merocyanine dye, phthalocyanine dye, triazine dye, benzotriazole dye, benzooxazole dye, aminobutadiene, azo-based dye, azomethine dye, pyridoporphyrazine dye, pyradporphyrazine dye, porphyrin dye, and porphyrazine dye.

[4] The optical information-recording medium according to any one of [1] to [3], wherein the dye compound is boronic acid.

[5] The optical information-recording medium according to [4], wherein the dye compound has a boroxin moiety formed by mutually bonding boronic acid molecules.

[6] The optical information-recording medium according to [4] or [5], wherein the dye compound is a compound represented by the following general formula (I), (II), (III), or (IV) or a polymer formed by mutually bonding one or more of the same:

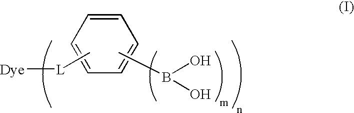

wherein Dye represents a dye residue, L represents a divalent linking group or a single bond, m represents an integer of 1 to 5, n represents an integer of 1 to 10, m may be equal to or not equal to n when n is not less than 2, and two or more of the linking groups L may be identical with each other or different from each other;

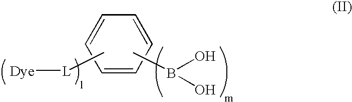

wherein 1 represents an integer of 1 to 5, m+1=2 to 6 is given herein, and two or more linking groups L and dye residues Dye may be identical with each other or different from each other when 1 is not less than 2;

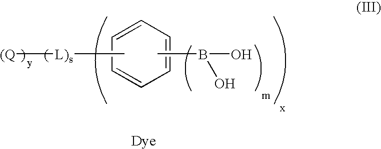

wherein Q represents a substituent having electric charge, y represents a number required for neutralization of electric charge, x represents a positive integer, Dye herein represents an ionic dye residue, s=0 is given when L is a single bond, s is an integer of 1 to 10 when L is a divalent linking group, and s=x is given in the case where s represents an integer of not less than 2; and

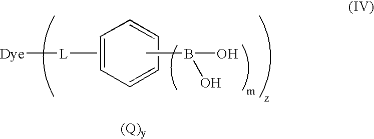

wherein Q represents a substituent having electric charge, y represents a number required for neutralization of electric charge, z represents a positive integer, and Dye herein represents an ionic dye residue.

[7] A method for producing an optical information-recording medium having, on a substrate, a recording layer capable of recording information by being irradiated with a laser beam, the method comprising:

a step of dissolving a dye compound containing boron as a constitutive element in a solvent to prepare a coating liquid;

a recording layer-forming step of applying the coating liquid onto the substrate to form a recording layer; and

a polymerizing step of polymerizing the dye compound by annealing the recording layer.

In the present invention, the dye compound, which contains boron as the constitutive element, is contained in the recording layer. Such a dye compound is satisfactory in the solubility in the solvent. Therefore, it is possible to easily prepare the coating liquid as a raw material for the recording layer.

Further, when the dye compound is used, the polymer is formed by the aid of the boron atom in the solution and in the step of forming the recording layer (in particular, in the annealing treatment). A hard amorphous film is thus obtained. Therefore, when the dye compound is contained in the recording layer of the optical information-recording medium, the recording performance is improved, because the adjacent interference is reduced.

That is, according to the present invention, it is possible to easily provide the recording layer which is excellent in the recording performance.

This effect is more remarkable when the boronic acid, more preferably the compound having the boroxin moiety is adopted as the dye compound containing boron as the constitutive element.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is, with partial omission, a sectional view illustrating a first optical information-recording medium;

FIG. 2 is, with partial omission, a sectional view illustrating a second optical information-recording medium; and

FIG. 3 is a table illustrating results of evaluation of solubilities of dye compounds C-72, C-37, H-1, H-2, H-3, and H-4 in 2,2,3,3-tetrafluoropropanol.

### DESCRIPTION OF THE PREFERRED EMBODIMENTS

The optical information-recording medium and the method for producing the same according to the present invention will be explained in detail below with reference to the accompanying drawings as exemplified by preferred embodiments.

In an optical information-recording medium according to an embodiment of the present invention, a recording layer, on which information can be recorded by being irradiated with the laser beam, is provided on a substrate. A dye compound, which contains a constitutive element of boron, is contained in the recording layer.

At first, an explanation will be made about the dye compound.

The form of boron is not specifically limited. However, preferred examples include boronic acid, dichloroboron, dibromoboron, and substituted or unsubstituted diaminoboronic acid. In particular, boronic acid and substituted or unsubstituted diaminoboronic acid are preferred, and boronic acid is especially preferred.

Preferred examples of boronic acid include linear or cyclic alkylboronic acid having 1 to 20 carbon atoms (for example, methyl, ethyl, n-propyl, isopropyl, and n-butyl), substituted or unsubstituted arylboronic acid having 6 to 18 carbon atoms (for example, phenyl, chlorophenyl, anisyl, toluoyl, 2,4-di-t-amyl, and 1-naphtyl), alkenylboronic acid (for example, vinyl and 2-methylvinyl), alkynylboronic acid (for example, ethynyl, 2-methylethynyl, and 2-phenylethynyl), heterocyclic boronic acid (for example, aromatic heterocyclic ring such as pyridyl, thienyl, furyl, thiazolyl, imidazolyl, and pyrazolyl, and aliphatic heterocyclic ring such as pyrrolidine ring, piperidine ring, morpholine ring, pyran ring, thiopyran ring, dioxane ring, and dithiolane ring), and hetero atom-connected boronic acid (for example, silicon atom and boron atom). Preferably, alkylboronic acid, arylboronic acid, and heterocyclic boronic acid are used. More preferably, arylboronic acid is used.

Preferred examples of arylboronic acid include phenylboronic acid, chlorophenylboronic acid, anisylboronic acid, toluoylboronic acid, 2,4-di-t-amylboronic acid, and 1-naphtylboronic acid. Preferably, phenylboronic acid and 1-naphtylboronic acid are used. More preferably, phenylboronic acid is used.

On the other hand, the dye is not specifically limited. It is allowable to use any known dye. As for the known dye, the dye residue thereof has an absorption maximum wavelength of 300 nm to 900 nm, and the molar absorption coefficient ε[L/(mol·cm)] is not less than 5,000.

Preferred examples of the dye include oxonol dye, cyanine dye, styryl dye, merocyanine dye, phthalocyanine dye, triazine dye, benzotriazole dye, benzooxazole dye, aminobutadiene, azo-based dye, azomethine dye, pyridoporphyrazine dye, pyradporphyrazine dye, porphyrin dye, and porphyrazine dye. In particular, oxonol dye, cyanine dye, styryl dye, merocyanine dye, phthalocyanine dye, triazine dye, benzotriazole dye, and azo-based dye are preferred. Oxonol dye, cyanine dye, styryl dye, and merocyanine dye are especially preferred.

Preferred examples of the boron dye compound as described above include the compounds represented by the following general formulas (I), (II), (III), and (IV):

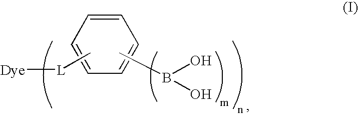

wherein Dye represents a dye residue, L represents a divalent linking group or a single bond, m represents an integer of 1 to 5, n represents an integer of 1 to 10, m may be equal to or not equal to n when n is not less than 2, and two or more of the linking groups L may be identical with each other or different from each other;

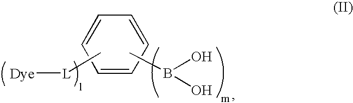

wherein 1 represents an integer of 1 to 5, m+1=2 to 6 is given herein, and two or more linking groups L and dye residues Dye may be identical with each other or different from each other when 1 is not less than 2;

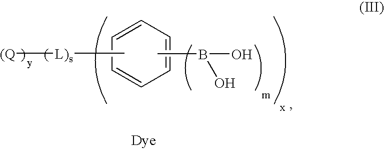

wherein Q represents a substituent having electric charge, y represents a number required for neutralization of electric charge, x represents a positive integer, Dye herein represents an ionic dye residue, s=0 is given when L is a single bond, s is an integer of 1 to 10 when L is a divalent linking group, and s=x is given in the case of an integer of not less than 2. That is, when L's are divalent linking groups and two or more of L's are present, then L is also included in the repeating unit; and

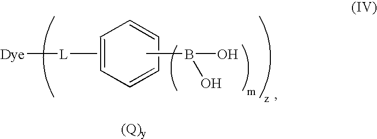

wherein Q represents a substituent having electric charge, y represents a number required for neutralization of electric charge, z represents a positive integer, and Dye herein represents an ionic dye residue.

In the general formulas (I) to (IV), Dye is each of the dye residues represented by oxonol dye, cyanine dye, merocyanine dye, phthalocyanine dye, triazine dye, benzotriazole dye, benzooxazole dye, aminobutadiene, azo-based dye, azomethine dye, pyridoporphyrazine dye, pyradporphyrazine dye, platinum porphyrin dye, and porphyrazine dye, preferably each of the dye residues of oxonol dye, cyanine dye, merocyanine dye, phthalocyanine dye, triazine dye, and benzotriazole dye, and more preferably each of the dye residues of oxonol dye and cyanine dye. The dye residues represented by Dye may be different from each other or identical with each other when n is not less than 2. However, it is preferable that the dye residues represented by Dye are identical.

In the general formulas (I) to (IV), L may be a single bond or a divalent linking group. In the case of the divalent linking group, preferred examples include substituted or unsubstituted alkyl linking (preferably those having 1 to 20 carbon atoms, for example, methyl, ethyl, n-propyl, isopropyl, n-butyl, n-pentyl, benzyl, 3-sulfopropyl, 4-sulfobutyl, 3-methyl-3-sulfopropyl, 2′-sulfobenzyl, carboxymethyl, and 5-carboxypentyl), substituted or unsubstituted alkenyl linking (preferably those having 2 to 20 carbon atoms, for example, vinyl and allyl), substituted or unsubstituted aryl linking (preferably those having 6 to 20 carbon atoms, for example, phenyl, 2-chlorophenyl, 4-methoxyphenyl, 3-methylphenyl, and 1-naphthyl), substituted or unsubstituted heterocyclic linking (preferably those having 1 to 20 carbon atoms, for example, pyridyl, thienyl, furyl, thiazolyl, imidazolyl, pyrazolyl, pyrrolidino, piperidino, and morpholino), hetero atom linking (preferably oxygen atom, nitrogen atom, boron atom, silicon atom, and stannum atom, and sulfur atom or sulfur oxide (sulfuryl and sulfo linking)). It is preferable to adopt substituted or unsubstituted alkyl linking, substituted or unsubstituted phenyl linking, substituted or unsubstituted heterocyclic ring linking, and hetero atom linking. It is more preferable to adopt substituted or unsubstituted phenyl linking or hetero atom linking.

In the general formulas (I) to (IV), m is an integer of 1 to 5, preferably 1 or 2, and more preferably 1.

In the general formula (I), it is enough that n is a positive integer. Preferably, n is 1 to 10, and more preferably 1 to 4.

In the general formula (II), l is an integer of 1 to 5, preferably 1 to 4, and more preferably 1 to 2.

In the general formulas (III) and (IV), Q represents a substituent having electric charge, and y represents a number required to neutralize the electric charge. Whether a certain compound is a cation or an anion or whether a certain compound has any net ion charge or not depends on the substituent of the compound. In the general formulas (III) and (IV), the ion, which is represented by Q, represents a cation in some cases or represents an anion in other cases depending on the electric charge of the corresponding dye molecule.

The ion, which is represented as Q, is not specifically limited, which may be either an ion composed of an inorganic compound or an ion composed of an organic compound. The electric charge of the ion represented as Q may be either monovalent or polyvalent.

The cation, which is represented as Q, includes, for example, onium ions such as quaternary ammonium ion, oxonium ion, sulfonium ion, phosphonium ion, selenonium ion, and iodonium ion.

The ion as the cation represented by Q is especially preferably onium ion, and more preferably quaternary ammonium ion. Among the quaternary ammonium ions, those especially preferred are 4,4′-bipyridinium cation represented by a general formula (I-4) described in Japanese Laid-Open Patent Publication No. 2000-52658, and 4,4′-bipyridinium cation disclosed in Japanese Laid-Open Patent Publication No. 2002-59652.

On the other hand, the anion, which is represented as Q, includes, for example, hetero polyacid ions such as sulfate ion, phosphate ion, and hydrogenphosphate ion, organic polyvalent anions such as carboxylate ion, succinate ion, maleate ion, fumarate ion, and aromatic disulfonate ion, tetrafluoroborate ion, and hexafluorophosphate ion.

The anion, which is represented by Q, is especially preferably hetero polyacid ion and organic polyvalent anion, and more preferably divalent or trivalent organic anion such as naphthalene disulfonate derivative. Among the divalent or trivalent organic anions, those especially preferred include naphthalene disulfonate anion disclosed in Japanese Laid-Open Patent Publication No. 10-226170.

In the general formula (III), x may be a positive integer, preferably 1 to 10, and more preferably 1 to 4.

In the general formula (IV), z may be a positive integer, preferably 1 to 10, and more preferably 1 to 4.

Specified examples of the compound of this type are shown below. However, it should be understood that the dye compound is not limited thereto in the present invention.

TABLE 1

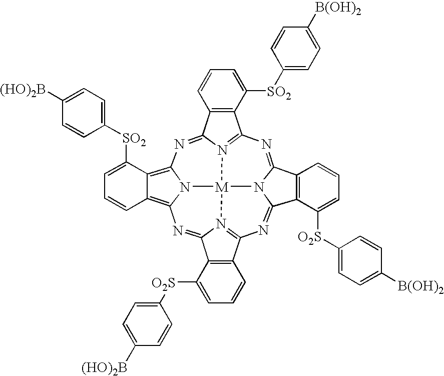

| No. | M |
|---|---|
| A-1 | Cu |
| A-2 | Mg |
| A-3 | Zn |

TABLE 2

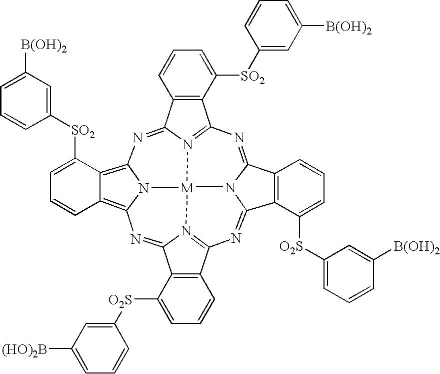

| No. | M |
|---|---|
| A-4 | Cu |
| A-5 | Mg |
| A-6 | Zn |

TABLE 3

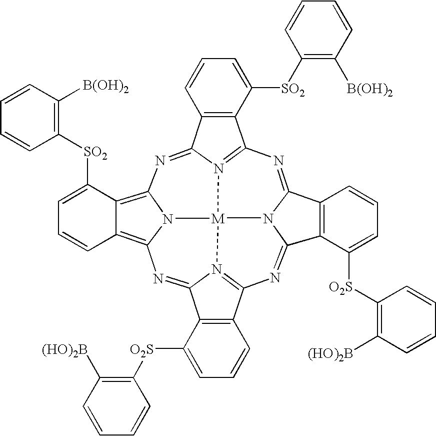

| No. | M |
|---|---|
| A-7 | Cu |
| A-8 | Mg |
| A-9 | Zn |

TABLE 4

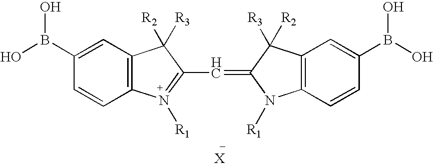

| No. | R₁ | R₂ | R₃ | X |
|---|---|---|---|---|
| A-10 | CH₃ | CH₃ | CH₃ | I |
| A-11 | C₂H₅ | CH₃ | CH₃ | I |
| A-12 | C₄H₉ | CH₃ | CH₃ | I |

TABLE 5

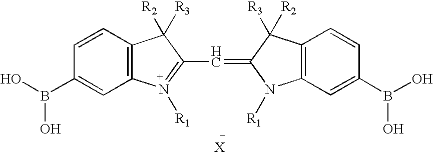

| No. | R₁ | R₂ | R₃ | X |
|---|---|---|---|---|
| A-13 | CH₃ | CH₃ | CH₃ | I |
| A-14 | C₂H₅ | CH₃ | CH₃ | I |
| A-15 | C₄H₉ | CH₃ | CH₃ | I |

TABLE 6

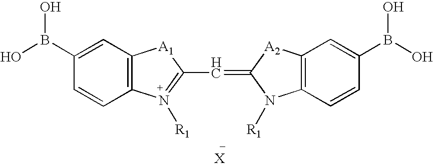

| No. | R1 | A1 | A2 |
|---|---|---|---|
| A-16 | CH₃ | O | O |
| A-17 | CH₃ | O | S |
| A-18 | C₄H₉ | O | O |
| A-19 | CH₃ | S | S |

TABLE 7

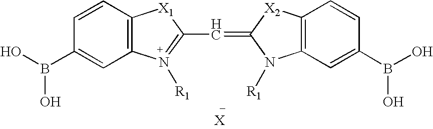

| No. | R₁ | A₁ | A₂ |
|---|---|---|---|
| A-20 | CH₃ | O | O |
| A-21 | CH₃ | O | S |
| A-22 | C₄H₉ | O | O |
| A-23 | CH₃ | S | S |

TABLE 8

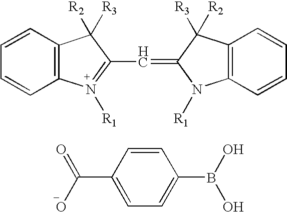

| No. | R₁ | R₂ | R₃ |
|---|---|---|---|
| A-24 | CH₃ | CH₃ | CH₃ |
| A-25 | C₂H₅ | CH₃ | CH₃ |
| A-26 | C₄H₉ | CH₃ | CH₃ |

TABLE 9

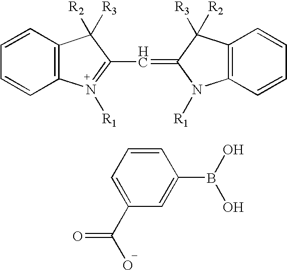

| No. | R₁ | R₂ | R₃ |
|---|---|---|---|
| A-27 | CH₃ | CH₃ | CH₃ |
| A-28 | C₂H₅ | CH₃ | CH₃ |
| A-29 | C₄H₉ | CH₃ | CH₃ |

TABLE 10

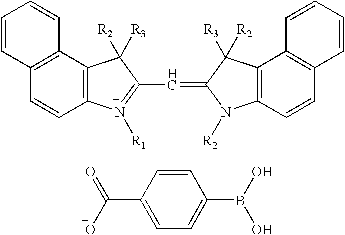

| No. | R₁ | R₂ | R₃ |
|---|---|---|---|
| A-30 | CH₃ | CH₃ | CH₃ |
| A-31 | C₂H₅ | CH₃ | CH₃ |
| A-32 | C₄H₉ | CH₃ | CH₃ |

TABLE 11

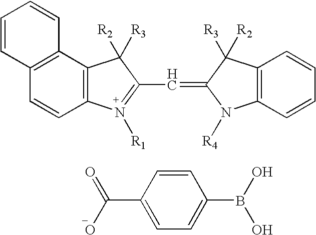

| No. | R₁ | R₂ | R₃ | R₄ |
|---|---|---|---|---|
| A-33 | C₄H₉ | CH₃ | CH₃ | CH₃ |
| A-34 | CH₃ | CH₃ | CH₃ | CH₃ |
| A-35 | C₄H₉ | CH₃ | CH₃ | C₄H₉ |
| A-36 | C₄H₉ | C₂H₅ | CH₃ | C₄H₉ |

TABLE 12

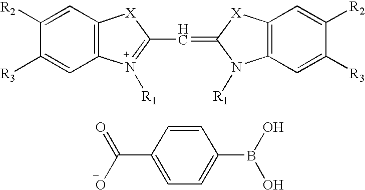

| No. | R1 | R2 | R3 | X |
|---|---|---|---|---|
| A-37 | CH₃ | H | H | O |
| A-38 | CH₃ | Br | H | O |
| A-39 | C₄H₉ | CH₃ | H | O |
| A-40 | CH₃ | H | H | S |
| A-41 | CH₃ | H | Cl | S |
| A-42 | CH₃ | —COCH₂CH₂OH | H | S |
| A-43 | CH₃ | Cl | Cl | O |

TABLE 13

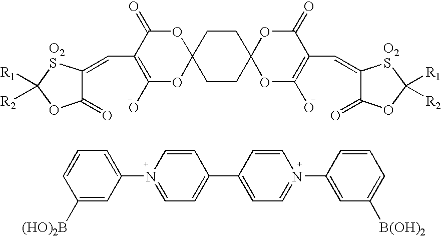

| No. | R1 | R2 |
|---|---|---|
| C-1 | CH₃ | CH₃ |
| C-2 | C₂H₅ | C₂H₅ |
| C-3 | C₃H₇ | CH₃ |

| | |
|---|---|
| C-4 | —(CH₂)₄— |
| C-5 | —(CH₂)₅— |
| C-6 | 2-Adamantyl |

TABLE 14

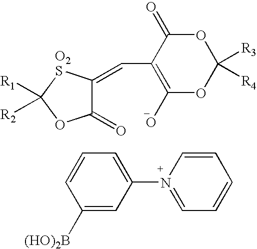

| No. | R1 | R2 | R3 | R4 |
|---|---|---|---|---|
| C-7 | CH₃ | CH₃ | CH₃ | CH₃ |

| | | |
|---|---|---|
| C-8 | —(CH₂)₄— | —(CH₂)₄— |

| | | | | |
|---|---|---|---|---|
| C-9 | C₂H₅ | C₂H₅ | C₂H₅ | C₂H₅ |

| | | |
|---|---|---|
| C-10 | —(CH₂)₅— | —(CH₂)₅— |

| | | | | |
|---|---|---|---|---|
| C-11 | C₃H₇ | CH₃ | C₃H₇ | CH₃ |

| | | |
|---|---|---|
| C-12 | 2-Adamantyl | 2-Adamantyl |

| | | | | |
|---|---|---|---|---|
| C-13 | C₃H₇ | CH₃ | CH₃ | CH₃ |

TABLE 15

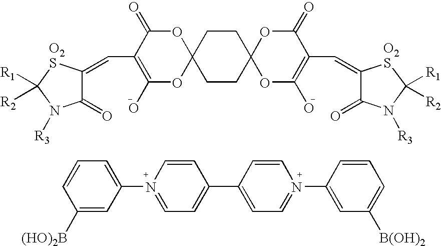

| No. | R1 | R2 | R3 |
|---|---|---|---|
| C-14 | CH₃ | CH₃ | H |
| C-15 | C₂H₅ | C₂H₅ | H |
| C-16 | C₃H₇ | CH₃ | H |
| C-17 | Ph | Ph | H |

| | | |
|---|---|---|
| C-18 | —(CH₂)₄— | H |
| C-19 | —(CH₂)₅— | H |
| C-20 | 2-Adamantyl | H |

| | | | |
|---|---|---|---|
| C-21 | C₃H₇ | CH₃ | C₃H₇ |
| C-22 | C₃H₇ | CH₃ | C₃H₇ |

| | | |
|---|---|---|
| C-23 | —(CH₂)₄— | C₃H₇ |
| C-24 | —(CH₂)₅— | C₃H₇ |
| C-25 | 2-Adamantyl | C₃H₇ |

TABLE 16

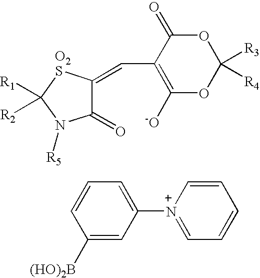

| No. | R1 | R2 | R3 | R4 | R5 |
|---|---|---|---|---|---|
| C-26 | CH₃ | CH₃ | CH₃ | CH₃ | H |
| C-27 | —(CH₂)₅— | | —(CH₂)₅— | | H |
| C-28 | C₃H₇ | CH₃ | C₃H₇ | CH₃ | H |
| C-29 | —(CH₂)₅— | | —(CH₂)₅— | | Ph |
| C-30 | CH₃ | CH₃ | CH₃ | CH₃ | C₃H₇ |
| C-31 | —(CH₂)₅— | | —(CH₂)₅— | | C₃H₇ |
| C-32 | C₃H₇ | CH₃ | C₃H₇ | CH₃ | C₃H₇ |

TABLE 17

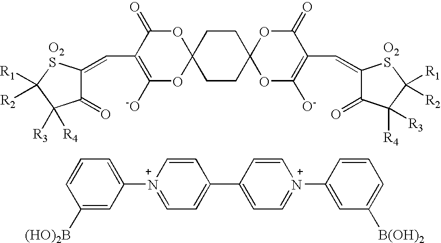

| No. | R1 | R2 | R3 | R4 |
|---|---|---|---|---|
| C-33 | CH₃ | CH₃ | H | H |
| C-34 | —(CH₂)₅— | | H | H |
| C-35 | H | Ph | Ph | H |
| C-36 | H | —(CH₂)₄— | | H |
| C-37 | H | H | H | H |
| C-38 | 2-Adamantyl | | H | H |

TABLE 18

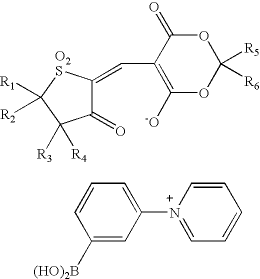

| No. | R1 | R2 | R3 | R4 | R5 | R6 |
|---|---|---|---|---|---|---|
| C-39 | CH₃ | CH₃ | H | H | CH₃ | CH₃ |
| C-40 | —(CH₂)₆— | | H | H | —(CH₂)₅— | |
| C-41 | H | Ph | Ph | H | —(CH₂)₅— | |
| C-42 | H | —(CH₂)₄— | | H | —(CH₂)₅— | |
| C-43 | H | H | H | H | —(CH₂)₅— | |
| C-44 | 2-Adamantyl | | H | H | —(CH₂)₅— | |
| C-45 | H | H | H | H | CH₃ | CH₃ |

TABLE 19

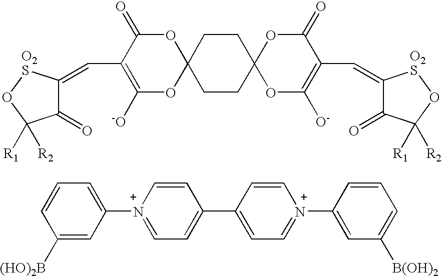

| No. | R1 | R2 |
|---|---|---|
| C-46 | CH₃ | CH₃ |
| C-47 | C₂H₅ | C₂H₅ |
| C-48 | C₃H₇ | CH₃ |
| C-49 | —(CH₂)₄— | |
| C-50 | —(CH₂)₅— | |
| C-51 | Ph | Ph |

TABLE 20

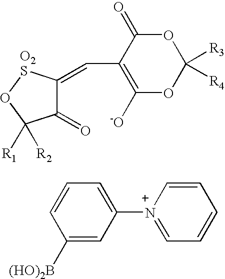

| No. | R1 | R2 | R3 | R4 |
|---|---|---|---|---|
| C-52 | CH₃ | CH₃ | CH₃ | CH₃ |
| C-53 | —(CH₂)₄— | | —(CH₂)₄— | |
| C-54 | C₂H₅ | C₂H₅ | C₂H₅ | C₂H₅ |
| C-55 | —(CH₂)₅— | | —(CH₂)₅— | |
| C-56 | C₃H₇ | CH₃ | C₃H₇ | CH₃ |
| C-57 | 2-Adamantyl | | 2-Adamantyl | |
| C-58 | C₃H₇ | CH₃ | CH₃ | CH₃ |

TABLE 21

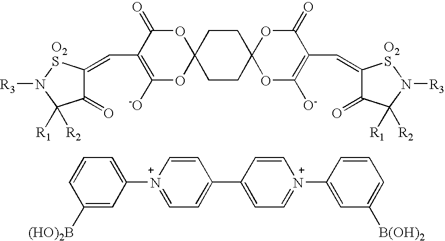

| No. | R1 | R2 | R3 |
|---|---|---|---|
| C-59 | CH₃ | CH₃ | H |
| C-60 | C₂H₅ | C₂H₅ | H |
| C-61 | C₃H₇ | CH₃ | H |
| C-62 | Ph | Ph | H |
| C-63 | —(CH₂)₄— | | H |
| C-64 | —(CH₂)₅— | | H |
| C-65 | 2-Adamantyl | | H |
| C-66 | C₃H₇ | CH₃ | C₃H₇ |
| C-67 | C₃H₇ | CH₃ | C₃H₇ |
| C-68 | —(CH₂)₄— | | C₃H₇ |
| C-69 | —(CH₂)₅— | | C₃H₇ |
| C-70 | 2-Adamantyl | | C₃H₇ |

TABLE 22

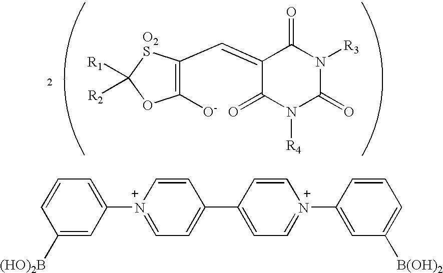

| No. | R1 | R2 | R3 | R4 |
|---|---|---|---|---|
| C-71 | CH₃ | CH₃ | CH₃ | CH₃ |
| C-72 | —(CH₂)₅— | | CH₃ | CH₃ |
| C-73 | C₂H₅ | C₂H₅ | C₂H₅ | C₂H₅ |
| C-74 | —(CH₂)₅— | | ^{Cyclo}C₅H₁₁ | ^{Cyclo}C₅H₁₁ |
| C-75 | —(CH₂)₅— | | C₃H₇ | C₃H₇ |
| C-76 | —(CH₂)₅— | | H | H |

TABLE 23

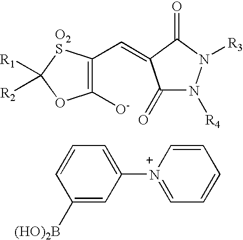

| No. | R1 | R2 | R3 | R4 |
|---|---|---|---|---|
| C-77 | CH₃ | CH₃ | CH₃ | CH₃ |
| C-78 | —(CH₂)₅— | | CH₃ | OH₃ |
| C-79 | C₂H₅ | C₂H₅ | C₂H₅ | C₂H₅ |
| C-80 | —(CH₂)₅— | | Ph | Ph |
| C-81 | —(CH₂)₅— | | CH₂Ph | CH₂Ph |
| C-82 | —(CH₂)₅— | | H | H |

TABLE 24

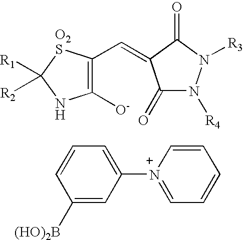

| No. | R1 | R2 | R3 | R4 |
|---|---|---|---|---|
| C-83 | CH₃ | CH₃ | CH₃ | CH₃ |
| C-84 | —(CH₂)₅— | | CH₃ | CH₃ |
| C-85 | C₂H₅ | C₂H₅ | C₂H₅ | C₂H₅ |
| C-86 | —(CH₂)₅— | | Ph | Ph |
| C-87 | —(CH₂)₅— | | CH₂Ph | CH₂Ph |
| C-88 | —(CH₂)₅— | | H | H |

TABLE 25

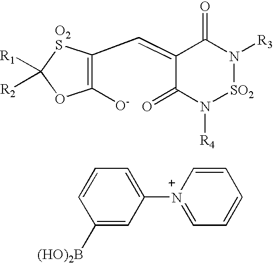

| No. | R1 | R2 | R3 | R4 |
|---|---|---|---|---|
| C-89 | CH₃ | CH₃ | CH₃ | CH₃ |
| C-90 | —(CH₂)₅— | | ^{sec}C₄H₉ | ^{sec}C₄H₉ |
| C-91 | C₂H₅ | C₂H₅ | C₂H₅ | C₂H₅ |
| C-92 | —(CH₂)₅— | | ^{t}C₄H₉ | ^{t}C₄H₉ |
| C-93 | —(CH₂)₅— | | C₃H₇ | C₃H₇ |
| C-94 | —(CH₂)₅— | | H | H |

TABLE 26

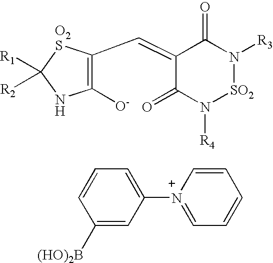

| No. | R1 | R2 | R3 | R4 |
|---|---|---|---|---|
| C-95 | CH₃ | CH₃ | CH₃ | CH₃ |
| C-96 | —(CH₂)₅— | | ^{sec}C₄H₉ | ^{sec}C₄H₉ |
| C-97 | C₂H₅ | C₂H₅ | C₂H₅ | C₂H₅ |
| C-98 | —(CH₂)₅— | | ^{t}C₄H₉ | ^{t}C₄H₉ |
| C-99 | —(CH₂)₅— | | C₃H₇ | C₃H₇ |
| C-100 | —(CH₂)₅— | | H | H |

TABLE 27

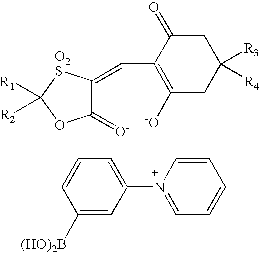

| No. | R1 | R2 | R3 | R4 |
|---|---|---|---|---|
| C-101 | CH₃ | CH₃ | CH₃ | CH₃ |
| C-102 | —(CH₂)₄— | | —(CH₂)₄— | |
| C-103 | C₂H₅ | C₂H₅ | C₂H₅ | C₂H₅ |
| C-104 | —(CH₂)₅— | | —(CH₂)₅— | |
| C-105 | C₃H₇ | CH₃ | C₃H₇ | CH₃ |
| C-106 | 2-Adamantyl | | 2-Adamantyl | |
| C-107 | C₃H₇ | CH₃ | CH₃ | CH₃ |

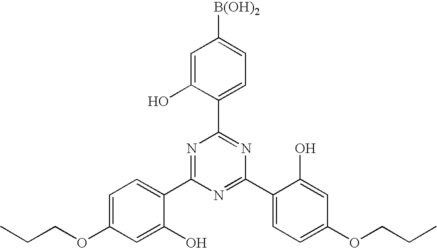

The dye compounds as described above may be used singly respectively. Alternatively, two or more of the dye compounds as described above may be used in combination. The dye compound containing boron and any dye compound other than the above may be used in combination for the recording layer.

When the dye compound is the boronic acid compound as represented by the general formulas (I) to (IV), it is assumed that the dye compound having the boron-oxygen bond in which boronic acid molecules are condensed with each other, i.e., the boroxin moiety is present in the recording layer after forming the recording layer of the optical information-recording medium.

It is known that the boroxin moiety is formed in accordance with the following reaction formula when the boronic acid is subjected to the condensation (for example, see “Heterocycles”, 2002, Vol. 57, p. 787). That is, when the recording layer of the optical information-recording medium is formed by using the dye compound according to the embodiment of the present invention, it is considered that the boroxin moiety is formed by the mutual condensation of boronic acid in the coating liquid for forming the recording layer or in the coating film (recording layer) formed by using the coating liquid. Additionally, the amorphous film, which constitutes the coating film, is hardened in accordance with the further formation of the boron-oxygen bond (boroxin moiety) when the coating film is heated and dried (subjected to the annealing treatment). The present inventors postulate that the polymer is gradually formed in the coating liquid, and a greater part of boronic acid forms the polymer by means of the annealing treatment, when the recording layer of the optical information-recording medium is formed. As described above, when the dye compound according to the embodiment of the present invention is used, then the boron-oxygen bond is formed in the recording layer, and the degree of hardening of the amorphous film is enhanced as compared with a case in which no boron atom is contained. As a result, the adjacent interference is reduced.

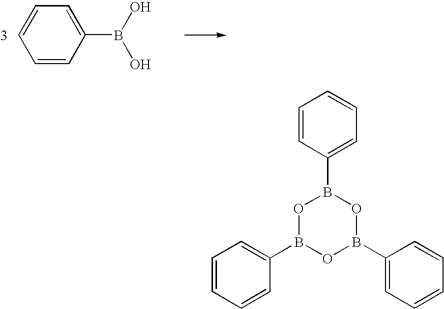

The dye compound as described above is excellent in the solubility in various solvents. Therefore, the coating liquid, which is the raw material for the recording layer, can be prepared with ease.

Further, as described above, the dye compound of this type forms a hard amorphous film. The adjacent interference is thus remarkably reduced. Therefore, the recording performance is improved.

That is, it is possible to achieve the establishment of both of the recording performance and the solubility by using the dye compound into which boron, preferably the boronic acid residue, or more preferably the boroxin moiety is introduced.

The recording layer of the optical information-recording medium according to the embodiment of the present invention may be formed of only the dye compound described above. However, it is also appropriate to contain various antifading agents in order to improve the light resistance of the recording layer.

The antifading agent may include organic oxidizing agents and singlet oxygen quenchers. Compounds described in Japanese Laid-Open Patent Publication No. 10-151861 are preferable as the organic oxidizing agent used as the antifading agent. Those having been already known and described in publications including, for example, patent documents can be used as the singlet oxygen quencher. Specified examples thereof may include those described in patent documents of Japanese Laid-Open Patent Publication Nos. 58-175693, 59-81194, 60-18387, 60-19586, 60-19587, 60-35054, 60-36190, 60-36191, 60-44554, 60-44555, 60-44389, 60-44390, 60-54892, 60-47069, 63-209995, 4-25492, and Japanese Patent Publication Nos. 1-38680 and 6-26028 respectively as well as German Patent No. 350399, and Nippon Kagaku Kaishi, p. 1141, October, 1992. Preferred examples of the singlet oxygen quencher may include a compound represented by the following general formula (V).

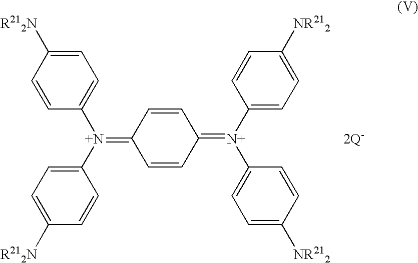

In the general formula (V), R²¹ represents an alkyl group which may have a substituent, and Q⁻ represents an anion.

In the general formula (V), R²¹ is generally an alkyl group which has 1 to 8 carbon atoms and which may be substituted. R²¹ is preferably an unsubstituted alkyl group having 1 to 6 carbon atoms. The substituent of the alkyl group may include halogen atom (for example, F and Cl), alkoxy group (for example, methoxy group and ethoxy group), alkylthio group (for example, methylthio group and ethylthio group), acyl group (for example, acetyl group and propionyl group), acyloxy group (for example, acetoxy group and propionyloxy group), hydroxyl group, alkoxycarbonyl group (for example, methoxycarbonyl group and ethoxycarbonyl group), alkenyl group (for example, vinyl group), and aryl group (for example, phenyl group and naphthyl group). Among them, it is preferable to adopt halogen atom, alkoxy group, alkylthio group, and alkoxycarbonyl group. Preferred examples of the anion Q⁻ may include ClO₄⁻, AsF₆⁻, BF₄⁻, and SbF₆⁻.

Specified examples of the compound represented by the general formula (V) are substances represented by the following compound numbers V-1 to V-8.

| Compound No. | R²¹ | Q⁻ |
|---|---|---|
| V-1 | CH₃ | ClO₄⁻ |
| V-2 | C₂H₅ | ClO₄⁻ |
| V-3 | n-C₃H₇ | ClO₄⁻ |
| V-4 | n-C₄H₉ | ClO₄⁻ |
| V-5 | n-C₅H₁₁ | ClO₄⁻ |
| V-6 | n-C₄H₉ | SbF₆⁻ |
| V-7 | n-C₄H₉ | BF₄⁻ |
| V-8 | n-C₄H₉ | AsF₆⁻ |

The amount of use of the antifading agent such as the singlet oxygen quencher as described above is usually within a range of 0.1 to 50% by weight, preferably within a range of 0.5 to 45% by weight, more preferably within a range of 3 to 40% by weight, and especially preferably within a range of 5 to 25% by weight with respect to the amount of the dye compound.

### Embodiments of Optical Information-Recording Medium

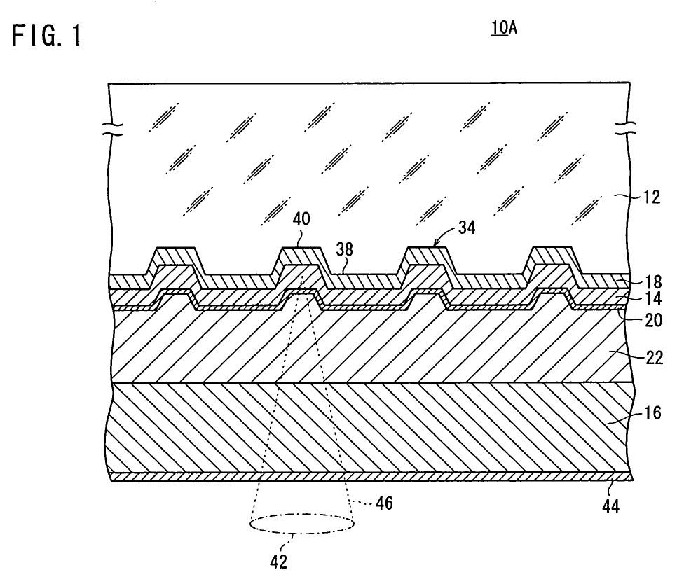

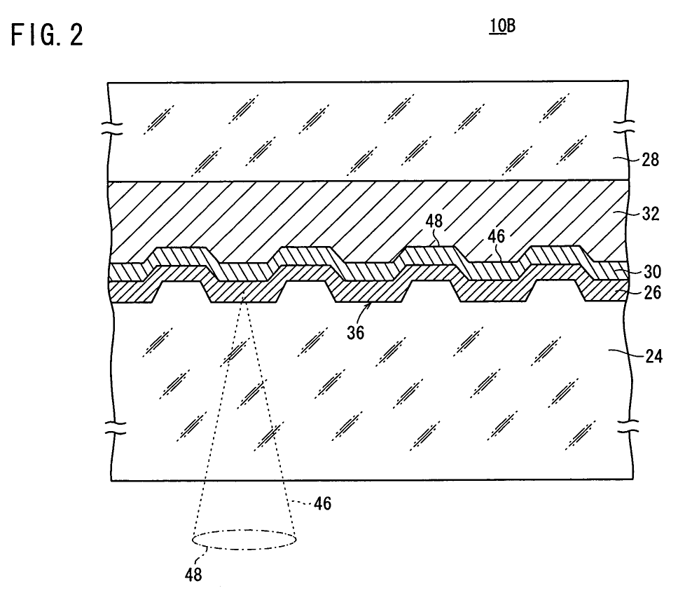

The optical information-recording medium of the present invention is preferably exemplified by an optical information-recording medium according to a first embodiment shown in FIG. 1 (hereinafter simply referred to as “first optical information-recording medium 10A”) and an optical information-recording medium according to a second embodiment shown in FIG. 2 (hereinafter simply referred to as “second optical information-recording medium 10B”).

As shown in FIG. 1, the first optical information-recording medium 10A has a first write-once type recording layer 14 which contains a dye, and a cover layer 16 which has a thickness of 0.01 to 0.5 mm, in this order on a first substrate 12 which has a thickness of 0.7 to 2 mm. Specifically, the first optical information-recording medium 10A has, for example, a first light-reflective layer 18, the first write-once type recording layer 14, a barrier layer 20, a first adhesive layer 22, and the cover layer 16 in this order on the first substrate 12.

As shown in FIG. 2, the second optical information-recording medium 10B has a second write-once type recording layer 26 which contains a dye, and a protective substrate 28 which has a thickness of 0.1 to 1.0 mm, in this order on a second substrate 24 which has a thickness of 0.1 to 1.0 mm. Specifically, the second optical information-recording medium 10B has, for example, the second write-once type recording layer 26, a second light-reflective layer 30, a second adhesive layer 32, and the protective substrate 28 in this order on the second substrate 24.

As shown in FIG. 1 it is preferable for the first optical information-recording medium 10A that a first pregroove 34 formed on the first substrate 12 has a track pitch of 50 to 500 nm, a groove width of 25 to 250 nm, and a groove depth of 5 to 150 nm.

As shown in FIG. 2 it is preferable for the second optical information-recording medium 10B that a second pregroove 36 formed on the second substrate 24 has a track pitch of 200 to 600 nm, a groove width of 50 to 300 nm, a groove depth of 30 to 200 nm, and a wobble amplitude of 10 to 50 nm.

As shown in FIG. 1, the first optical information-recording medium 10A has such a form that at least the first substrate 12, the first write-once type recording layer 14, and the cover layer 16 are provided. At first, an explanation will be made about members essential for these components.

### First Substrate 12 of First Optical Information-Recording Medium 10A

As shown in FIG. 1, it is essential that the first pregroove 34 (guide groove), which has such a shape that all of the track pitch, the groove depth, the groove width (half value of width: width of the groove at the point of ½ of the groove depth), and the wobble amplitude are within the following ranges, is formed on the first substrate 12 of the preferred first optical information-recording medium 10A. The first pregroove 34 is provided in order to achieve the recording density higher than those of CD-Rs and DVD-Rs. High recording density is preferred, for example, when the first optical information-recording medium 10A is used as a medium adapted to the blue-violet laser.

It is essential that the track pitch of the first pregroove 34 is within a range of 50 to 500 nm. The upper limit value is preferably not more than 420 nm, more preferably not more than 370 nm, and much more preferably not more than 330 nm. The lower limit value is preferably not less than 100 nm, more preferably not less than 200 nm, and much more preferably not less than 260 nm.

If the track pitch is less than 50 nm, it is difficult to form the first pregroove 34 correctly. Further, the crosstalk tends to arise. If the track pitch exceeds 500 nm, the recording density is lowered.

It is appropriate that the groove width (half value of width) of the first pregroove 34 is within a range of 25 to 250 nm. Further, the upper limit value is preferably not more than 200 nm, more preferably not more than 170 nm, and much more preferably not more than 150 nm. The lower limit value is preferably not less than 50 nm, more preferably not less than 80 nm, and much more preferably not less than 100 nm.

If the groove width of the first pregroove 34 is less than 25 nm, then the groove is not transferred sufficiently during the formation in some cases, and the error rate may be raised during the recording in other cases. If the groove width exceeds 250 nm, the pit formed upon the recording is consequently widened. The crosstalk is caused in some cases, and sufficient modulation degree is not obtained in other cases.

It is appropriate that the groove depth of the first pregroove 34 is within a range of 5 to 150 nm. The upper limit value is preferably not more than 100 nm, more preferably not more than 70 nm, and much more preferably not more than 50 nm. The lower limit value is preferably not less than 10 nm, more preferably not less than 20 nm, and much more preferably not less than 28 nm.

If the groove depth of the first pregroove 34 is less than 5 nm, sufficient recording modulation degree may not be obtained. If the groove depth exceeds 150 nm, the reflectance may greatly be lowered.

As for the angle of groove inclination of the first pregroove 34, the upper limit value is preferably not more than 80°, more preferably not more than 70°, much more preferably not more than 60°, and especially preferably not more than 50°. The lower limit value is preferably not less than 20°, more preferably not less than 30°, and much more preferably not less than 40°.

If the angle of groove inclination of the first pregroove 34 is less than 20°, any sufficient tracking error signal amplitude may not be obtained. If the angle of groove inclination exceeds 80°, it is difficult to form the first substrate 12, for example, by injection molding.

Various materials having been used as the substrate material for conventional optical information-recording mediums can be arbitrarily used for the first substrate 12 for the first optical information-recording medium 10A.

Specifically, examples of the substrate material include glass; acrylic resin such as polycarbonate and polymethyl methacrylate; vinyl chloride-based resin such as polyvinyl chloride and vinyl chloride copolymer; epoxy resin; amorphous polyolefin; polyester; and metal such as aluminum. These materials may be used in combination, if desired.

Among the materials described above, the thermoplastic resin such as amorphous polyolefin and polycarbonate is preferred, and polycarbonate is especially preferred, in view of, for example, the humidity resistance, the dimensional stability, and the low price.

When the resin as described above is used, the first substrate 12 can be manufactured by using injection molding.

It is appropriate that the thickness of the first substrate 12 is within a range of 0.7 to 2 mm. The thickness is preferably within a range of 0.9 to 1.6 mm, and more preferably 1.0 to 1.3 mm.

It is preferable that an undercoat layer is formed on the surface of the first substrate 12 on the side on which the first light-reflective layer 18 is provided as described later on in order to impart the flatness and improve adhesive force.

Examples of the material for the undercoat layer include high molecular weight compounds such as polymethyl methacrylate, acrylic acid-methacrylic acid copolymer, styrene-maleic anhydride copolymer, polyvinyl alcohol, N-methylolacrylamide, styrene-vinyltoluene copolymer, chlorosulfonated polyethylene, nitrocellulose, polyvinyl chloride, chlorinated polyolefin, polyester, polyimide, vinyl acetate-vinyl chloride copolymer, ethylene-vinyl acetate copolymer, polyethylene, polypropylene, and polycarbonate; and surface-modifying agents such as a silane coupling agent.

The undercoat layer can be formed such that the material as described above is dissolved or dispersed in an appropriate solvent to prepare a coating liquid, and the surface of the first substrate 12 is coated with the coating liquid by a coating method such as the spin coating, the dip coating, and the extrusion coating. The layer thickness of the undercoat layer is generally within a range of 0.005 to 20 μm, and preferably within a range of 0.01 to 10 μm.

### First Write-Once Type Recording Layer 14 of First Optical Information-Recording Medium 10A

The first write-once type recording layer 14 of the preferred first optical information-recording medium 10A is formed as follows. That is, a dye is dissolved together with a binding agent in an appropriate solvent to prepare a coating liquid. Subsequently, the coating liquid is applied onto the substrate or onto the first light-reflective layer 18 as described later on to form a coating film, and then dried. In this embodiment, the first write-once type recording layer 14 may be a single layer or a multilayer. In the case of the multilayer structure, the step of applying the coating liquid is performed more than one.

The concentration of the dye in the coating liquid is generally within a range of 0.01 to 15% by mass, preferably within a range of 0.1 to 10% by mass, more preferably within a range of 0.5 to 5% by mass, and most preferably within a range of 0.5 to 3% by mass.

Examples of the solvent of the coating liquid include esters such as butyl acetate, ethyl lactate, and cellosolve acetate; ketones such as methyl ethyl ketone, cyclohexanone, and methyl isobutyl ketone; chlorinated hydrocarbons such as dichloromethane, 1,2-dichloroethane, and chloroform; amides such as dimethylformamide; hydrocarbons such as methylcyclohexane; ethers such as tetrahydrofuran, ethyl ether, and dioxane; alcohols such as ethanol, n-propanol, isopropanol, n-butanol, and diacetone alcohol; fluorine-based solvents such as 2,2,3,3-tetrafluoropropanol; and glycol ethers such as ethylene glycol monomethyl ether, ethylene glycol monoethyl ether, and propylene glycol monomethyl ether.

The solvent as described above may be used singly, or in combination in consideration of the solubility of the dye to be used. Further, various additives including, for example, antioxidants, UV-absorbing agents, plasticizers, and lubricants may be added into the coating liquid depending on the purpose.

Examples of the coating method include the spray method, the spin coat method, the dip method, the roll coat method, the blade coat method, the doctor roll method, and the screen printing method.

When the coating is performed, the temperature of the coating liquid is preferably within a range of 23 to 50° C., more preferably within a range of 24 to 40° C.

The thickness of the first write-once type recording layer 14 formed as described above is preferably not more than 300 nm on the groove 38 (convex portion on the first substrate 12), more preferably not more than 250 nm, much more preferably not more than 200 nm, and especially preferably not more than 180 nm. The lower limit value is preferably not less than 30 nm, more preferably not less than 50 nm, much more preferably not less than 70 nm, and especially preferably not less than 90 nm.

The thickness of the first write-once type recording layer 14 on the land 40 (concave portion on the first substrate 12) is preferably not more than 400 nm, more preferably not more than 300 nm, and much more preferably not more than 250 nm. The lower limit value is preferably not less than 70 nm, more preferably not less than 90 nm, and much more preferably not less than 110 nm.

The ratio (t1/t2) between the thickness t1 of the first write-once type recording layer 14 on the groove 38 and the thickness t2 of the first write-once type recording layer 14 on the land 40 is preferably not less than 0.4, more preferably not less than 0.5, much more preferably not less than 0.6, and especially preferably not less than 0.7. The upper limit value is preferably less than 1, more preferably not more than 0.9, much more preferably not more than 0.85, and especially preferably not more than 0.8.

When the coating liquid contains the binding agent, examples of the binding agent include natural organic high molecular weight substances including, for example, gelatin, cellulose derivatives, dextran, rosin, and rubber; and synthetic organic high molecular weight substances including, for example, hydrocarbon-based resins such as polyethylene, polypropylene, polystyrene, and polyisobutylene, vinyl-based resins such as polyvinyl chloride, polyvinylidene chloride, and polyvinyl chloride-polyvinyl acetate copolymer, acrylic resins such as polymethyl acrylate and polymethyl methacrylate, polyvinyl alcohol, chlorinated polyethylene, epoxy resin, butyral resin, rubber derivative, and initial condensate of thermosetting resin such as phenol-formaldehyde resin. When the binding agent is used as the material for the first write-once type recording layer 14 in combination, the amount of use of the binding agent is generally within a range of 0.01 to 50 times of the dye by mass ratio, preferably within a range of 0.1 to 5 times by mass ratio.

The first write-once type recording layer 14 may contain various antifading agents in order to improve the light resistance of the first write-once type recording layer 14. A singlet oxygen quencher is generally used as the antifading agent. Those known from patent document publications can be used as the singlet oxygen quencher.

Specified examples thereof include those described in Japanese Laid-Open Patent Publication Nos. 58-175693, 59-81194, 60-18387, 60-19586, 60-19587, 60-35054, 60-36190, 60-36191, 60-44554, 60-44555, 60-44389, 60-44390, 60-54892, 60-47069, 63-209995, 4-25492, and Japanese Patent Publication Nos. 1-38680 and 6-26028 respectively as well as German Patent No. 350399, and Nippon Kagaku Kaishi, p. 1141, October, 1992.

The amount of use of the antifading agent such as the singlet oxygen quencher is usually within a range of 0.1 to 50% by mass, preferably within a range of 0.5 to 45% by mass, more preferably within a range of 3 to 40% by mass, and especially preferably within a range of 5 to 25% by mass with respect to the amount of the dye.

### Cover Layer 16 of First Optical Information-Recording Medium 10A

The cover layer 16 of the preferred first optical information-recording medium 10A is stuck onto the first write-once type recording layer 14 described above or the barrier layer 20 described later on by the first adhesive layer 22 composed of, for example, an adhesive or a sticking agent.

The cover layer 16 to be used for the first optical information-recording medium 10A is not specifically limited as far as it is transparent. However, it is preferable to use, for example, acrylic resin such as polycarbonate and polymethyl methacrylate; vinyl chloride-based resin such as polyvinyl chloride and vinyl chloride copolymer, epoxy resin; amorphous polyolefin; polyester; and cellulose triacetate. In particular, it is more preferable to use polycarbonate or cellulose triacetate.

The term “transparent” means the fact that the transmittance is not less than 80% with respect to the light to be used for the recording and reproduction.

Various additives may be contained in the cover layer 16 within a range in which the effect of the present invention is not inhibited. For example, it is also allowable to contain a UV-absorbing agent for cutting the light having a wavelength of not more than 400 nm, and/or a dye for cutting the light having a wavelength of not less than 500 nm.

As for the surface physical properties of the cover layer 16, it is preferable that both of the two-dimensional roughness parameter and the three-dimensional roughness parameter are not more than 5 nm in relation to the surface roughness.

It is preferable that the birefringence of the cover layer 16 is not more than 10 nm in view of the light-focusing degree of the light to be used for the recording and reproduction.

The thickness of the cover layer 16 is appropriately prescribed depending on the wavelength of the laser beam radiated for the recording and reproduction and NA of the first objective lens 42. However, the thickness of the cover layer 16 is within a range of 0.01 to 0.5 mm, more preferably, within a range of 0.05 to 0.12 mm in the first optical information-recording medium 10A.

The total thickness of the cover layer 16 and the adhesive layer 22 in combination is preferably 0.09 to 0.11 mm, and more preferably 0.095 to 0.105 mm.

A hard coat layer 44 (protective layer) may be provided on the light-incoming surface of the cover layer 16 in order to avoid any scratch on the light-incoming surface during the production of the first optical information-recording medium 10A.

As for the adhesive to be used for the adhesive layer 22, it is preferable to use, for example, UV-curable resin, EB-curable resin, and thermosetting resin. It is especially preferable to use UV-curable resin.

When the UV-curable resin is used as the adhesive, then the UV-curable resin may be used as it is, or the UV-curable resin may be dissolved in an appropriate solvent such as methyl ethyl ketone or ethyl acetate to prepare a coating liquid, which may be supplied from a dispenser to the surface of the barrier layer 20. In order to avoid warpage of the first optical information-recording medium 10A to be manufactured, it is preferable that the UV-curable resin for forming the adhesive layer 22 has a small coefficient of curing contraction. Such a UV-curable resin may include, for example, UV-curable resins such as “SD-640” available from DAINIPPON INK AND CHEMICALS, INCORPORATED.

The adhesive is preferably used as follows: a predetermined amount of the adhesive is applied onto the objective sticking surface composed of the barrier layer 20. After the cover layer 16 is placed thereon, the adhesive is spread by spin coating so that it is uniformly spread between the objective sticking surface and the cover layer 16, and then cured.

The thickness of the adhesive layer 22 composed of the adhesive as described above is preferably within a range of 0.1 to 100 μm, more preferably within a range of 0.5 to 50 μm, and much more preferably within a range of 10 to 30 μm.

Acrylic, rubber-based, and silicone-based adhesives may be used as the sticking agent for the adhesive layer 22. It is preferable to use the acrylic sticking agent in view of the transparency and the durability. Those preferably usable as the acrylic sticking agent as described above contain the main component of, for example, 2-ethylhexyl acrylate or n-butyl acrylate. In order to improve cohesion, the main component may be copolymerized with short chain alkyl acrylate or methacrylate, such as methyl acrylate, ethyl acrylate, or methyl methacrylate, and acrylic acid, methacrylic acid, acrylamide derivative, maleic acid, hydroxyethyl acrylate, glycidyl acrylate or the like each capable of serving as the crosslinking point with the crosslinking agent. The glass transition temperature (Tg) and the crosslinking density can be changed appropriately in the type and the mixing ratio of the main component, the short chain component, and the component to add the crosslinking point.

Examples of the crosslinking agent, which is used in combination with the sticking agent as described above, include isocyanate-based crosslinking agents. Those usable as the isocyanate-based crosslinking agent may include isocyanates such as tolylenediisocyanate, 4,4′-diphenylmethane diisocyanate, hexamethylene diisocyanate, xylylene diisocyanate, naphthylene-1,5-diisocyanate, o-toluidine isocyanate, isophorone diisocyanate, and triphenylmethane triisocyanate, products of isocyanates and polyalcohols, and polyisocyanates produced by condensation of isocyanates. Commercially available products of isocyanates as described above may include, for example, CORONATE L, CORONATE HL, CORONATE 2030, CORONATE 2031, MILLIONATE MR, and MILLIONATE HTL available from NIPPON POLYURETHANE CO., LTD.; TAKENATE D-102, TAKENATE D-110N, TAKENATE D-200, and TAKENATE D-202 available from TAKEDA; and Desmodule L, Desmodule IL, Desmodule N, and Desmodule HL available from Sumitomo-Bayer.

A predetermined amount of the sticking agent may be applied uniformly onto the objective sticking surface composed of the barrier layer 20. The cover layer 16 may be placed thereon, and then the sticking agent is cured. Alternatively, a predetermined amount of the sticking agent may be previously applied uniformly onto one surface of the cover layer 16 to form a coating film of the sticking agent. The coating film may be stuck to the objective sticking surface, and then the sticking agent is cured.

A commercially available adhesive film previously provided with a sticking agent layer in advance may be used for the cover layer 16.

The thickness of the adhesive layer 22 composed of the sticking agent as described above is preferably within a range of 0.1 to 100 μm, more preferably within a range of 0.5 to 50 μm, and much more preferably within a range of 10 to 30 μm.

### Other Layers of First Optical Information-Recording Medium 10A

The preferred first optical information-recording medium 10A may have other arbitrary layer in addition to the essential layers described above within a range in which the effect of the present invention is not deteriorated. The other arbitrary layer includes, for example, a label layer which has a desired image and which is formed on the back surface of the first substrate 12 (back surface with respect to the surface of formation of the first write-once type recording layer 14), the first light-reflective layer 18 (described later on) which is provided between the first substrate 12 and the first write-once type recording layer 14, the barrier layer 20 (described later on) which is provided between the first write-once type recording layer 14 and the cover layer 16, and an interface layer which is provided between the first light-reflective layer 18 and the first write-once type recording layer 14. In this embodiment, the label layer is formed by using, for example, an ultraviolet-curable resin, a thermosetting resin, and a thermal drying resin.

Any one of the essential and arbitrary layers may be a single layer, or have a multilayer structure.

### First Light-Reflective Layer 18 of First Optical Information-Recording Medium 10A

It is preferable to form the first light-reflective layer 18 between the first substrate 12 and the first write-once type recording layer 14 in order to enhance the reflectance with respect to the laser beam and/or add the function to improve the recording and reproduction characteristics in the first optical information-recording medium 10A.

As for the first light-reflective layer 18, a light-reflective substance, which has a high reflectance with respect to the laser beam, can be formed on the substrate by vacuum vapor deposition, sputtering, or ion plating.

The layer thickness of the first light-reflective layer 18 is generally within a range of 10 to 300 nm, and preferably within a range of 50 to 200 nm.

The reflectance is preferably not less than 70%.

The light-reflective substance having the high reflectance may include stainless steel, half metal or metal such as Mg, Se, Y, Ti, Zr, Hf, V, Nb, Ta, Cr, Mo, W, Mn, Re, Fe, Co, Ni, Ru, Rh, Pd, Ir, Pt, Cu, Ag, Au, Zn, Cd, Al, Ga, In, Si, Ge, Te, Pb, Po, Sn, and Bi. The light-reflective substance as described above may be used singly, in combination, or as an alloy. In particular, it is preferable to use Cr, Ni, Pt, Cu, Ag, Au, Al, and stainless steel. It is especially preferable to use Au, Ag, Al, or an alloy thereof, and most preferable to use Au, Ag, or an alloy thereof.

### Barrier Layer 20 (Intermediate Layer) of First Optical Information-Recording Medium 10A

It is preferable to form the barrier layer 20 between the first write-once type recording layer 14 and the cover layer 16 in the first optical information-recording medium 10A.

The barrier layer 20 is provided, for example, in order that the first write-once type recording layer 14 keeps a high quality adhesion between the first write-once type recording layer 14 and the cover layer 16, the reflectance is adjusted, and the coefficient of thermal conductivity is adjusted.

The material to be used for the barrier layer 20 is not specifically limited as far as the light beam to be used for the recording and reproduction is transmitted through the material, and the material can express the function as described above. Examples of the material generally include materials having a low permeability of gas and water, and being a dielectric.

Specifically, the material is preferably composed of nitride, oxide, carbide, or sulfide of, for example, Zn, Si, Ti, Te, Sn, Mo, and Ge. It is preferable to use ZnS, MoO₂, GeO₂, TeO, SiO₂, TiO₂, ZuO, ZnS—SiO₂, SnO₂, and ZnO—Ga₂O₃. It is more preferable to use ZnS—SiO₂, SnO₂, and ZnO—Ga₂O₃.

The barrier layer 20 can be formed by means of the vacuum film formation method including, for example, the vacuum vapor deposition, the DC sputtering, the RF sputtering, and the ion plating. In particular, it is more preferable to use the sputtering, and much more preferable to use the RF sputtering.

The thickness of the barrier layer 20 is preferably within a range of 1 to 200 nm, more preferably within a range of 2 to 100 nm, and much more preferably within a range of 3 to 50 nm.

Next, the second optical information-recording medium 10B will be explained with reference to FIG. 2.

The second optical information-recording medium 10B is the optical information-recording medium having the sticking type layer structure. The representative layer structures are as follows.

(1) As shown in FIG. 2, the first layer structure is constructed such that a second write-once type recording layer 26, a second light-reflective layer 30, and a second adhesive layer 32 are successively formed on a second substrate 24, and a protective substrate 28 is provided on the second adhesive layer 32.

(2) Although not shown, the second layer structure is constructed such that a second write-once type recording layer 26, a second light-reflective layer 30, a protective layer, and a second adhesive layer 32 are successively formed on a second substrate 24, and a protective substrate 28 is provided on the second adhesive layer 32.

(3) Although not shown, the third layer structure is constructed such that a second write-once type recording layer 26, a second light-reflective layer 30, a protective layer, a second adhesive layer 32, and a protective layer are successively formed on a second substrate 24, and a protective substrate 28 is provided on the protective layer.

(4) Although not shown, the fourth layer structure is constructed such that a second write-once type recording layer 26, a second light-reflective layer 30, a protective layer, a second adhesive layer 32, a protective layer, and a light-reflective layer are successively formed on a second substrate 24, and a protective substrate 28 is provided on the light-reflective layer.

(5) Although not shown, the fifth layer structure is constructed such that a second write-once type recording layer 26, a second light-reflective layer 30, a second adhesive layer 32, and a light-reflective layer are successively formed on a second substrate 24, and a protective substrate 28 is provided on the light-reflective layer.

The layer structures (1) to (5) are mere examples, and the order of the layers described above may be replaced or omitted in part. The second write-once type recording layer 26 may also be formed on the side of the protective substrate 28. In this case, the recording and reproduction can be performed on the both surfaces of the optical information-recording medium. Further, each of the layers may be composed of a single layer or a plurality of layers.

The second optical information-recording medium 10B will now be explained below as exemplified by the structure having the second write-once type recording layer 26, the second light-reflective layer 30, the second adhesive layer 32, and the protective substrate 28 in this order on the second substrate 24 as shown in FIG. 2.

### Second Substrate 24 of Second Optical Information-Recording Medium 10B

It is essential that the second pregroove 36 (guide groove), which has such a shape that all of the track pitch, the groove width (half value of width), the groove depth, and the wobble amplitude are within the following ranges, is formed on the second substrate 24 of the second optical information-recording medium 10B. The second pregroove 36 is provided in order to achieve the recording density higher than those of CD-Rs and DVD-Rs. High recording density is preferred, for example, when the second optical information-recording medium 10B is used as a medium adapted to the blue-violet laser.

It is appropriate that the track pitch of the second pregroove 36 is within a range of 200 to 600 nm. The upper limit value is preferably not more than 500 nm, more preferably not more than 450 nm, and much more preferably not more than 430 nm. The lower limit value is preferably not less than 300 nm, more preferably not less than 330 nm, and much more preferably not less than 370 nm.

If the track pitch is less than 200 nm, it is difficult to form the second pregroove 36 correctly. Further, the crosstalk tends to arise. If the track pitch exceeds 600 nm, the recording density is lowered.

It is appropriate that the groove width (half value of width) of the second pregroove 36 is within a range of 50 to 300 nm. The upper limit value is preferably not more than 250 nm, more preferably not more than 200 nm, and much more preferably not more than 180 nm. The lower limit value is preferably not less than 100 nm, more preferably not less than 120 nm, and much more preferably not less than 140 nm.

If the groove width of the second pregroove 36 is less than 50 nm, then the groove is not transferred sufficiently during the formation in some cases, and the error rate is raised during the recording in other cases. If the groove width exceeds 300 nm, the pit formed upon the recording is consequently widened. The crosstalk is caused in some cases, and sufficient modulation degree is not obtained in other cases.

It is appropriate that the groove depth of the second pregroove 36 is within a range of 30 to 200 nm. The upper limit value is preferably not more than 170 nm, more preferably not more than 140 nm, and much more preferably not more than 120 nm. The lower limit value is preferably not less than 40 nm, more preferably not less than 50 nm, and much more preferably not less than 60 nm.

If the groove depth of the second pregroove 36 is less than 30 nm, sufficient recording modulation degree may not be obtained. If the groove depth exceeds 200 nm, the reflectance may be greatly lowered.

Various materials having been used as the substrate material for conventional optical information-recording medium can be arbitrarily used for the second substrate 24 for the second optical information-recording medium 10B. Specified examples and preferred examples are the same as or equivalent to those for the first substrate 12 of the first optical information-recording medium 10A.

It is appropriate that the thickness of the second substrate 24 is within a range of 0.1 to 1.0 mm. The thickness is preferably within a range of 0.2 to 0.8 mm, and more preferably within a range of 0.3 to 0.7 mm.

It is preferable that an undercoat layer is formed on the surface of the second substrate 24 on the side on which the second write-once type recording layer 26 is provided as described later on in order to impart flatness and improve adhesive force. Specified examples and preferred examples of the material for the undercoat layer, the coating method, and the layer thickness are the same as or equivalent to those for the undercoat layer of the first optical information-recording medium 10A.

### Second Write-Once Type Recording Layer 26 of Second Optical Information-Recording Medium 10B

Detailed description about the second write-once type recording layer 26 of the preferred second optical information-recording medium 10B is the same as or equivalent to that about the first write-once type recording layer 14 of the first optical information-recording medium 10A.

### Second Light-Reflective Layer 30 of Second Optical Information-Recording Medium 10B

The second light-reflective layer 30 may be formed on the second write-once type recording layer 26 in order to enhance the reflectance with respect to the laser beam and/or add the function to improve the recording and reproduction characteristics in the second optical information-recording medium 10B. Details of the second light-reflective layer 30 of the second optical information-recording medium 10B are the same as or equivalent to those of the first light-reflective layer 18 of the first optical information-recording medium 10A.

### Second Adhesive Layer 32 of Second Optical Information-Recording Medium 10B

The second adhesive layer 32 of the preferred second optical information-recording medium 10B is an arbitrary layer formed to improve the tight contact performance between the second light-reflective layer 30 and the protective substrate 28.

A photocurable resin is preferable as the material for the second adhesive layer 32. In particular, in order to avoid warpage of the disk, it is preferable that the material has a small coefficient of curing contraction. Such a photocurable resin may include, for example, UV-curable resins (UV-curable adhesives) such as “SD-640” and “SD-347” available from DAINIPPON INK AND CHEMICALS, INCORPORATED. It is preferable that the thickness of the second adhesive layer 32 is within a range of 1 to 1,000 μm in order to provide the elasticity or resilience.

### Protective Substrate 28 of Second Optical Information-Recording Medium 10B

A substrate, which is the same in the material and the shape as those of the second substrate 24 described above, can be used for the protective substrate 28 (dummy substrate) of the preferred second optical information-recording medium 10B. It is necessary that the thickness of the protective substrate 28 is within a range of 0.1 to 1.0 mm. The thickness is preferably within a range of 0.2 to 0.8 mm, and more preferably within a range of 0.3 to 0.7 mm.

### Protective Layer (not shown) of Second Optical Information-Recording Medium 10B

The second optical information-recording medium 10B is sometimes provided with the protective layer in order to physically and chemically protect, for example, the second light-reflective layer 30 and the second write-once type recording layer 26 depending on the layer structure.

Examples of the material to be used for the protective layer include inorganic substances such as ZnS, ZnS—SiO₂, SiO, SiO₂, MgF₂, SnO₂, and Si₃N₄, and organic substances such as thermoplastic resins, thermosetting resins, and UV-curable resins.

The protective layer can be formed, for example, such that a film, which is obtained by the extrusion processing of plastic, is stuck onto the light-reflective layer by an adhesive. Alternatively, the protective layer may be provided by the method including, for example, the vacuum vapor deposition, the sputtering, and the coating.

When the thermoplastic resin or the thermosetting resin is used for the protective layer, the protective layer can also be formed such that a coating liquid is prepared by dissolving the rein in an appropriate solvent. Next, the coating liquid is applied, and then dried. In the case of the UV-curable resin, the protective layer can also be formed such that a coating liquid is prepared by using the resin as it is or by dissolving the resin in an appropriate solvent, and thus prepared coating liquid is applied, and then cured by radiating the UV light. Various additives such as an antistatic agent, an antioxidant, and a UV-absorbing agent may be added to the coating liquid depending on the purpose. The layer thickness of the protective layer is generally within a range of 0.1 μm to 1 mm.

### Other Layers of Second Optical Information-Recording Medium 10B

The second optical information-recording medium 10B may have other arbitrary layer in addition to the layers described above within a range in which the effect of the present invention is not deteriorated. Detailed description about the other arbitrary layers is the same as or equivalent to that for the other layers of the first optical information-recording medium 10A.

### Optical Information-Recording Method

The optical information-recording method of the present invention is performed, for example, as follows by using the first optical information-recording medium 10A or the second optical information-recording medium 10B.

When the first optical information-recording medium 10A is used, the recording laser beam 46 such as the semiconductor laser beam is firstly radiated from the side of the cover layer 16 via the first objective lens 42 having a numerical aperture NA of, for example, 0.85, while rotating the first optical information-recording medium 10A at a constant linear velocity (0.5 to 10 m/second) or a constant angular velocity. It is assumed that when the radiation of the laser beam 46 locally raises temperature of the first write-once type recording layer 14 due to absorption of the laser beam 46, the physical or chemical change (for example, the pit formation) is caused so that the optical characteristics are changed, resulting in information recording.

Similarly, when the second optical information-recording medium 10B is used, the recording laser beam 46 such as the semiconductor laser beam is firstly radiated from the side of the second substrate 24 via the second objective lens 48 having a numerical aperture NA of, for example, 0.65, while rotating the second optical information-recording medium 10B at a constant linear velocity (0.5 to 10 m/second) or a constant angular velocity. It is assumed that when the radiation of the laser beam 46 locally raises temperature of the second write-once type recording layer 26 due to absorption of the laser beam 46, the physical or chemical change (for example, the pit formation) is caused so that change the optical characteristics are changed, resulting in information recording.

In the embodiment of the present invention, the semiconductor laser beam, which has the emission wavelength within a range of 390 to 450 nm, is used as the recording laser beam 46. The light source may preferably include the blue-violet semiconductor laser beam having an emission wavelength within a range of 390 to 415 nm, and the blue-violet SHG laser beam having a center emission wavelength of 425 nm in which the wavelength is made half using an optical waveguide element for the infrared semiconductor laser beam having a center emission wavelength of 850 nm. In particular, it is preferable to use the blue-violet semiconductor laser beam having an emission wavelength within a range of 390 to 415 nm in view of the recording density. The information, which has been recorded as described above, can be reproduced such that the semiconductor laser beam is radiated from the side of the substrate or the side of the protective layer, and the reflected light beam is detected, while rotating the first optical information-recording medium at the same constant linear velocity as that described above.

As for the laser beam, it is also possible to use, for example, the laser beam in the near infrared region (laser beam usually having a wavelength in the vicinity of 780 nm), the visible laser beam (630 nm to 680 nm), and the laser beam having a wavelength of not more than 530 nm (blue laser of 405 nm). However, it is more preferable to use the visible laser beam (630 nm to 680 nm) and the laser beam having a wavelength of not more than 530 nm (blue laser of 405 nm). It is especially preferable to use the laser beam having a wavelength of not more than 530 nm (blue laser of 405 nm).

### EXAMPLES

Next, the present invention will be explained in further detail below in accordance with Examples. However, the present invention is not limited to Examples described below.

### Synthesis of Compounds for Examples Synthesis of Dye Compound C-72

The dye compound C-72 was synthesized in accordance with the following schemes (1) and (2).

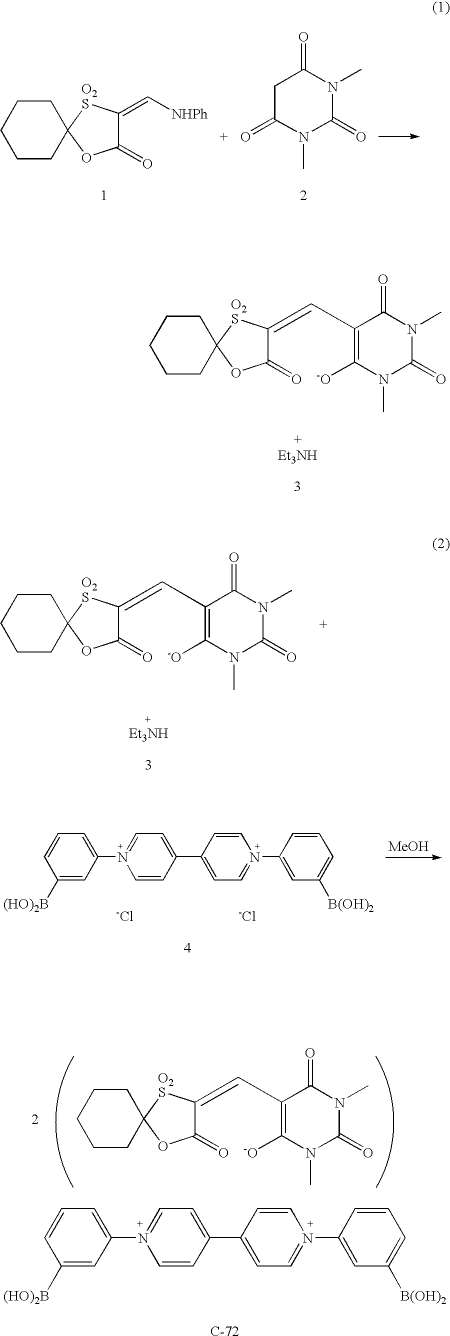

17.3 g of the compound 1 and 8.78 g of the compound 2 were dissolved in 200 ml of acetonitrile, and 5.31 ml of acetic anhydride was added dropwise while being stirred. Further, 7.91 ml of triethylamine was added dropwise. The reaction was performed at 80° C. for 1 hour. Then, after evaporating and removing the solvent, the purification was performed by means of silica gel chromatography to obtain 19.6 g of the compound 3.

2 g of the compound 3 was added to 20 ml of methanol, and 1 g of the compound 4 was added while being stirred, and then heated and refluxed. After performing the reaction for 4 hours, the product was left and cooled to a room temperature. The product was then introduced into 100 ml of acetonitrile, and filtrated to obtain 2.8 g of crystals of C-72. The structure was confirmed by NMR. The NMR data is as follows:

¹H NMR (DMSO-d⁶): δ=1.3 (m, 1H), 1.5 (m, 3H), 1.75 (m, 6H), 3.1 (d, 6H), 7.8 (t, 1H), 8.0 (s, 1H), 8.05 (s, 1H), 8.20 (2H, m), 8.52 (s, 2H), 9.05 (d, 2H), 9.72 (d, 2H).

### Synthesis of Dye Compound C-37

The dye compound C-37 was synthesized in accordance with the following schemes (3) and (4).

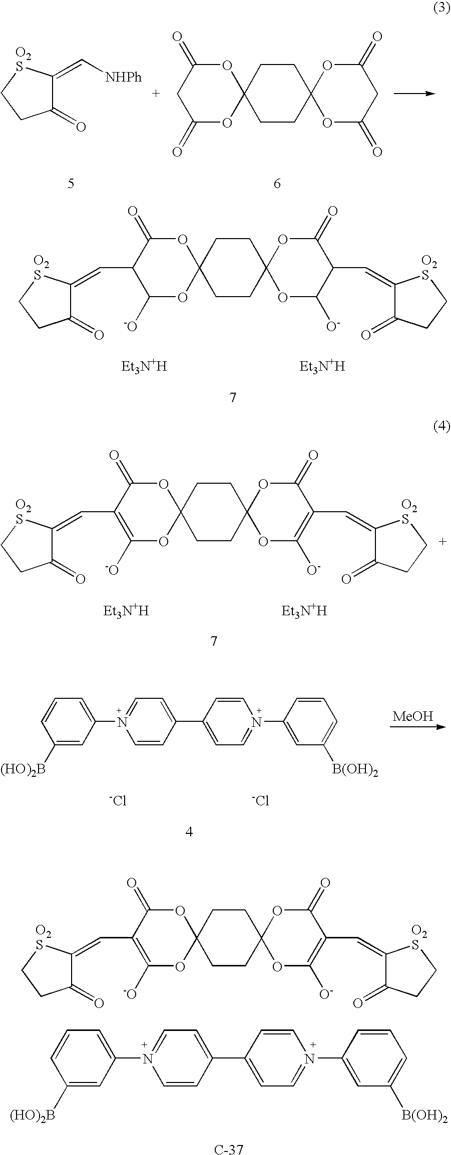

10.5 g of the compound 6 was added to 110 ml of N,N′-dimethylformamide and cooled to 0° C. After that, 18.6 ml of triethylamine was added while being stirred, and then 10.5 g of the compound 5 was added. After that, the reaction was performed at 0° C. for 5 hours. The reaction solution was introduced into 400 ml of ethyl acetate, and then filtrated to obtain the compound 7 of yellow crystals.

0.387 g of the compound 7 was added to 20 ml of methanol, and 0.234 g of the compound 4 was added while being stirred, and then heated and refluxed. The reaction was performed for 3 hours, and the resultant was left to be cooled to a room temperature, and filtrated to obtain 0.3 g of crystals of C-37. The structure was confirmed by NMR. The NMR data is as follows:

¹H NMR (DMSO-d⁶): δ=2.01 (s, 8H), 2.61 (dd, 4H), 3.12 (dd, 4H), 7.81 (m, 4H), 8.00 (m, 2H), 8.18 (m, 2H), 8.21 (s, 2H), 8.50 (s, 4H), 9.08 (d, 4H), 9.70 (d, 4H).

The other compounds can be also synthesized in accordance with the schemes in conformity with those described above.

### Synthesis of Compounds for Comparative Examples Synthesis of Dye Compound H-1

The dye compound H-1 containing no boron as the constitutive element was synthesized in accordance with the following scheme (5).

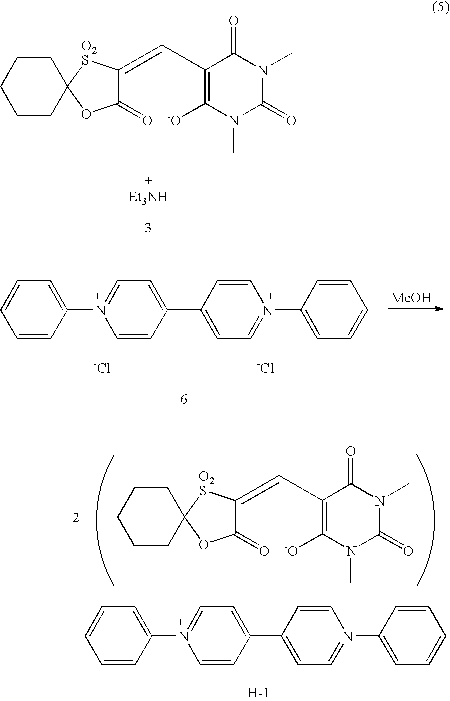

0.68 g of the compound 3 was added to 20 ml of methanol, and 0.28 g of the compound 8 was added while being stirred, and heated and refluxed. The reaction was performed for 3 hours, and the resultant was left to be cooled to a room temperature. The filtration was performed, and the product was introduced into 50 ml of methanol to obtain 0.5 g of crystals of H-1. The structure was confirmed by NMR. The NMR data is as follows.

¹H NMR (DMSO-d⁶): δ=1.3 (m, 1H), 1.5 (m, 3H), 1.75 (m, 6H), 3.1 (d, 6H), 8.05 (s, 1H), 8.25 (5H, s (br)), 9.15 (d, 2H), 9.75 (d, 2H).

### Synthesis of Dye Compound H-2

The dye compound H-2 containing no boron as the constitutive element was synthesized in accordance with the following scheme (6).

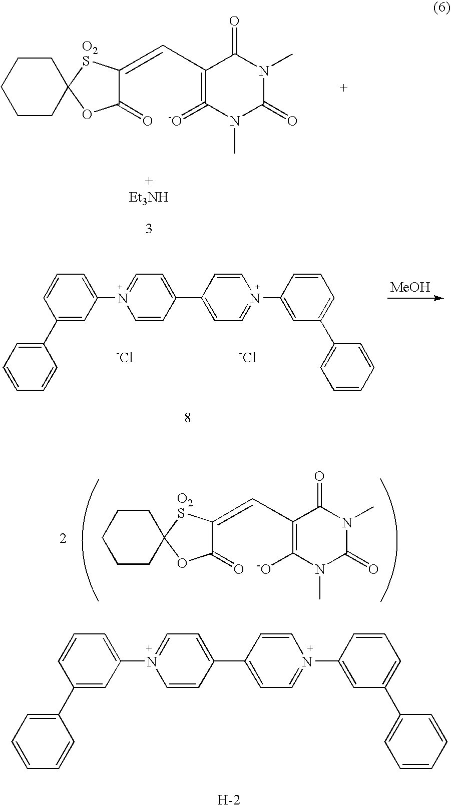

0.47 g of the compound 3 was added to 20 ml of methanol, and 0.27 g of the compound 9 was added while being stirred, and then heated and refluxed. The reaction was performed for 3 hours, and the resultant was left to be cooled to a room temperature. The filtration was performed, and the filtered product was introduced into 40 ml of methanol to obtain 0.4 g of crystals of H-2. The structure was confirmed by NMR. The NMR data is as follows:

¹H NMR (DMSO-d⁶): δ=1.3 (m, 1H), 1.5 (m, 3H), 1.75 (m, 6H), 3.1 (d, 6H), 7.45 to 7.62 (m, 4H), 7.85 (m, 3H), 8.05 (s, 1H), 8.10 (s, 1H), 8.30 (s, 1H), 9.15 (d, 2H), 9.82 (d, 2H).

### Synthesis of Dye Compound H-3

The dye compound H-3 containing no boron as the constitutive element was synthesized in accordance with the following scheme (7).

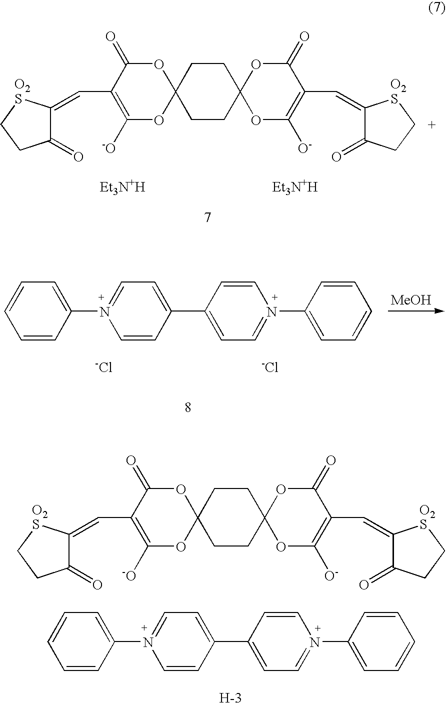

0.2 g of the compound 7 was added to 10 ml of methanol, and 0.10 g of the compound 8 was added while being stirred, and then heated and refluxed. The reaction was performed for 3 hours, and the resultant was left to be cooled to a room temperature. The filtration was performed, and the filtered product washed with 40 ml of methanol to obtain 0.2 g of crystals of the comparative compound H-3. The structure was confirmed by NMR. The NMR data is as follows:

¹H NMR (DMSO-d⁶): δ=2.00 (s, 8H), 2.61 (dd, 4H), 3.14 (dd, 4H), 7.81 (s, 2H), 7.78 to 7.98 (m, 5H), 9.07 (s, 4H), 9.71 (s, 4H).

### Synthesis of Dye Compound H-4

The dye compound H-4 containing no boron as the constitutive element was synthesized in accordance with the following scheme (8).

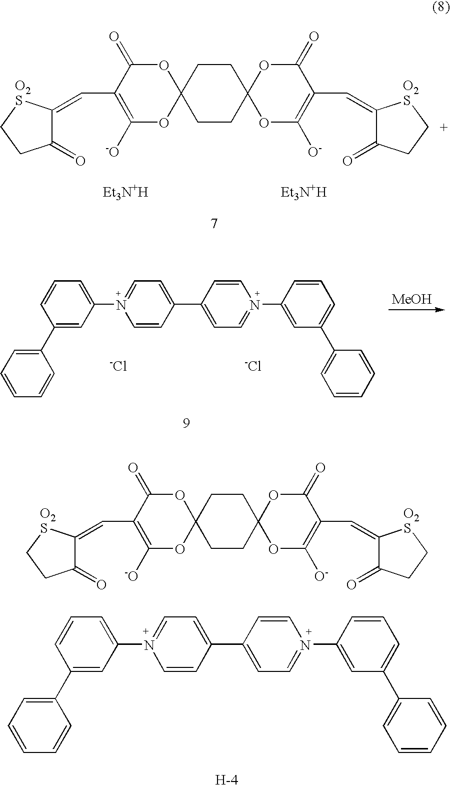

0.2 g of the compound 7 was added to 10 ml of methanol, and 0.13 g of the compound 9 was added while being stirred, and then heated and refluxed. The reaction was performed for 3 hours, and the resultant was left to be cooled to a room temperature. The filtration was performed, and the filtered product washed with 30 ml of methanol to obtain 0.21 g of crystals of the comparative compound H-4. The structure was confirmed by NMR. The NMR data is as follows:

¹H NMR (DMSO-d⁶): δ=1.99 (s, 8H), 2.60 (dd, 4H), 3.14 (dd, 4H), 7.50 (m, 2H), 7.55 (t, 4H), 7.80 (s, 2H), 7.85 (m, 4H), 7.94 to 8.30 (m, 8H), 9.12 (d, 4H), 9.82 (d, 4H).

### Production of Optical Information-Recording Medium Manufacturing of Substrate

An injection molding substrate composed of polycarbonate resin was manufactured, which had a thickness of 0.6 mm, an outer diameter of 120 mm, and an inner diameter of 15 mm and which was provided with a spiral-shaped pregroove (track pitch: 400 nm, groove width: 190 nm, groove depth: 90 nm, groove inclination angle: 650, wobble amplitude: 20 nm). The mastering of a stamper used for the injection molding was performed by using the laser cutting (351 nm).

### Formation of Write-Once Type Recording Layer

2 g of each of the dye compound C-72 and the dye compound C-37 was added and dissolved in 100 ml of 2,2,3,3-tetrafluoropropanol to prepare each of dye-containing coating liquids.

Subsequently, the substrate was coated with the prepared dye-containing coating liquid under a condition of 23° C. and 50% RH while changing the number of revolutions from 300 to 4,000 rpm by means of the spin coat method, and then left at 23° C. and 50% RH for 1 hour to form a write-once type recording layer (thickness on the groove: 40 nm, thickness on the land: 10 nm).

After forming the write-once type recording layer, the annealing treatment was applied with a clean oven by retaining and supporting the substrate at 80° C. for 1 hour while providing the space with a spacer for a perpendicular stack pole.

As a result of the annealing treatment, each of the dye compound C-72 and the dye compound C-37 was condensed to form the boroxin moiety.

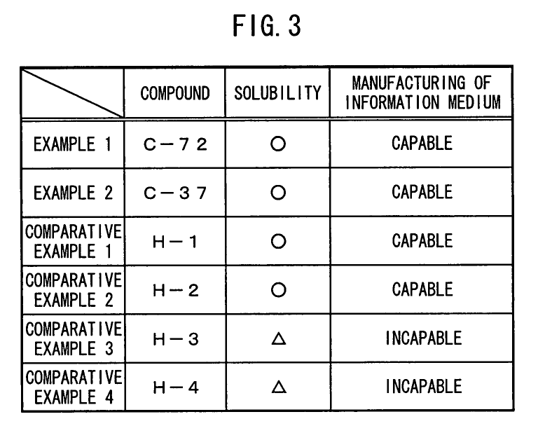

The dye compounds H-1 to H-4 as the compounds of Comparative Examples were also tried to be dissolved in 2,2,3,3-tetrafluoropropanol. The solubilities of the dye compounds H-1 to H-4 in 2,2,3,3-tetrafluoropropanol are shown in FIG. 3 together with the solubilities of the dye compound C-72 and the dye compound C-37.

According to FIG. 3, it is clear that the dye compound C-72 and the dye compound C-37, each of which contains boron as the constitutive element, have the solubilities which are larger than those of the dye compounds H-1 to H-4. In particular, the solubilities of the dye compounds H-3, H-4 are small with respect to 2,2,3,3-tetrafluoropropanol. For this reason, it was impossible to provide any recording layer.

### Formation of Light-Reflective Layer

An ANC light-reflective layer (Ag: 98.4% by mass, Ni: 0.7% by mass, Cu: 0.9% by mass) was formed as a vacuum film formation layer having a film thickness of 100 nm on the write-once type recording layer by the DC sputtering in an Ar atmosphere by using Cube produced by Unaxis. The film thickness of the light-reflective layer was adjusted by controlling the sputtering time.

### Sticking of Protective Substrate

The light-reflective layer was coated with an ultraviolet-curable resin (SD 640 available from DAINIPPON INK AND CHEMICALS, INCORPORATED) by means of the spin coating method. A protective substrate made of polycarbonate (equivalent to the substrate described above except for no formation of the pregroove) was stuck, and then cured by radiating the ultraviolet light. The adhesive layer composed of the ultraviolet-curable resin had a thickness of 25 μm in the manufactured optical information-recording medium.

### Evaluation of Optical Information-Recording Medium Evaluation of C/N (Carrier-to-Noise Ratio)

A signal (2T) of 0.204 μm was recorded and reproduced on the optical information-recording medium containing the dye compound C-72 or the dye compound H-2 in the recording layer of the manufactured optical information-recording media at a clock frequency of 64.8 MHz and a linear velocity of 6.61 m/s by using a recording and reproduction evaluating machine (DDU 1000 produced by PulseTech) carried with a pickup for a laser beam of 405 nm and NA=0.65. C/N after the recording was measured by using a spectrum analyzer (FSP 3 produced by ROHDE & SCHWARZ). The recording was performed at every 1 mW within a range of the peak power value of 3 to 12 mW. In this procedure, the measurement was performed for a range of 0 to 34 MHz while making the setting of RBW=30 kHz, VBW=10 kHz, sweep=30 msec, and ave=128 cyc. The difference between the carrier output C at 2T frequency and the noise output N at 34 MHz was regarded as the C/N value.

After that, the random recording was performed to measure PRSNR. During the recording, the light emission pattern and the peak power during the recording were optimized. The recording was performed for 3 tracks, and the PRSNR value of the central track was regarded as the evaluated value.

In this evaluation, the information was recorded on the groove. The recording power was 12 mW, and the reproducing power was 0.5 mW. In this case, the preferred recording characteristics are the reproduced signal intensity sufficient when C/N after the recording is not less than 25 dBm, or are reproduced signal quality sufficient when PRSNR is not less than 15.

In the case of the optical information-recording medium based on the use of the dye compound C-72, the maximum C/N at 2T was 27 dBm. After that, when the random recording was performed to measure PRSNR, the value was 29. On the contrary, in the case of the optical information-recording media using on the use of the dye compounds H-1, H-2, PRSNR's were 22 and 26, although the maximum C/N's at 2T were 26 and 29 dBm respectively, any one of which was inferior to the optical information-recording medium using the dye compound C-72.

As clearly understood from the above, the reproduced signal, in which the quality is satisfactory, is obtained on the optical information-recording medium provided with the recording layer containing the dye compound C-72 containing boron as the constitutive element as compared with the optical information-recording medium based on the dye compound H-1 not containing boron as the constitutive element. This means the fact that the adjacent interference is reduced in the recording layer using the dye compound C-72.

According to the results described above, it has been confirmed that the optical information-recording medium, which satisfies both of the solubility in the coating solvent and the satisfactory recording quality, is obtained by using the dye compound containing boron as the constitutive element. In particular, the foregoing effect is obtained by using the laser having a shorter wavelength as compared with CD-R and DVD-R. Therefore, the optical information-recording medium, which has the higher density, can be provided.

Although certain preferred embodiments of the present invention have been shown and described in detail, it should be understood that various changes and modifications may be made therein without departing from the scope of the appended claims.

What is claimed is:

1. An optical information-recording medium having, on a substrate, a recording layer capable of recording information by being irradiated with a laser beam, wherein
said recording layer contains a dye compound which contains boron as a constitutive element.

2. The optical information-recording medium according to claim 1, wherein said dye compound has a dye residue having an absorption maximum wavelength of 300 nm to 900 nm, and a molar absorption coefficient ε[L/(mol·cm)] of said dye compound is not less than 5,000.

3. The optical information-recording medium according to claim 1, wherein said dye compound is a dye selected from the group consisting of oxonol dye, cyanine dye, styryl dye, merocyanine dye, phthalocyanine dye, triazine dye, benzotriazole dye, benzooxazole dye, aminobutadiene, azo-based dye, azomethine dye, pyridoporphyrazine dye, pyradporphyrazine dye, porphyrin dye, and porphyrazine dye.

4. The optical information-recording medium according to claim 1, wherein said dye compound is boronic acid.

5. The optical information-recording medium according to claim 4, wherein said dye compound has a boroxin moiety formed by mutually bonding boronic acid molecules.

6. The optical information-recording medium according to claim 4, wherein said dye compound is a compound represented by the following general formula (I), (II), (III), or (IV), or a polymer formed by mutually bonding one or more of the compounds represented by the following general formulae (I), (II), (III) and (IV): 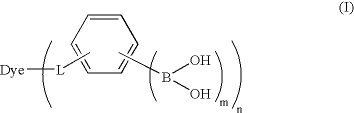
wherein Dye represents a dye residue, L represents a divalent linking group or a single bond, m represents an integer of 1 to 5, n represents an integer of 1 to 10, m may be equal to or not equal to n when n is not less than 2, and two or more of said linking groups L may be identical with each other or different from each other; 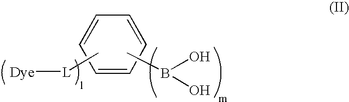
wherein l represents an integer of 1 to 5, m+l=2 to 6 is given herein, and two or more linking groups L and dye residues Dye may be identical with each other or different from each other when l is not less than 2; 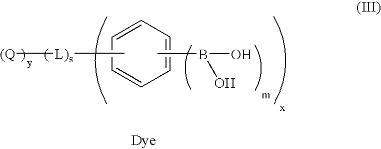
wherein Q represents a substituent having electric charge, y represents a number required for neutralization of electric charge, x represents an integer of 1 to 10, Dye herein represents an ionic dye residue, s=0 is given when L is a single bond, s is a positive integer when L is a divalent linking group, and s=x is given in the case where represents an integer of not less than 2; and 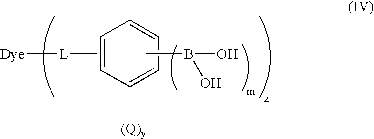
wherein Q represents a substituent having electric charge, y represents a number required for neutralization of electric charge, z represents a positive integer, and Dye herein represents an ionic dye residue.

7. A method for producing an optical information-recording medium having, on a substrate, a recording layer capable of recording information by being irradiated with a laser beam, said method comprising:
a step of dissolving a dye compound containing boron as a constitutive element in a solvent to prepare a coating liquid;
a recording layer-forming step of applying said coating liquid onto said substrate to form said recording layer; and
a polymerizing step of polymerizing said dye compound by annealing said recording layer.
